(19) United States
(12) Patent Application Publication
(10) Pub. No.: US 2009/0193184 A1
(43) Pub. Date: Jul. 30, 2009

(54) Hybrid 2-Level Mapping Tables for Hybrid Block- and Page-Mode Flash-Memory System

(75) Inventors: Frank Yu, Palo Alto, CA (US); Charles C. Lee, Cupertino, CA (US); Abraham C. Ma, Fremont, CA (US); Myeongjin Shin, San Ramon, CA (US)

Correspondence Address: STUART T AUVINEN, 429 26TH AVENUE, SANTA CRUZ, CA, 95062-5319, US

(73) Assignee: SUPER TALENT ELECTRONICS INC., San Jose, CA (US)

(21) Appl. No.: 12/418,550

(22) Filed: Apr. 3, 2009

Related U.S. Application Data
(63) Continuation-in-part of application No. 12/252,155, filed on Oct. 15, 2008.
Application No. 12/252,155 is a continuation-in-part of application No. 10/707,277, filed on Dec. 2, 2003, now Pat. No. 7,103,684.
Application No. 10/707,277 is a continuation-in-part of application No. 12/101,877, filed on Apr. 11, 2008.
Application No. 12/101,877 is a continuation-in-part of application No. 11/926,743, filed on Oct. 29, 2007.
Application No. 11/926,743 is a continuation-in-part of application No. 11/924,448, filed on Oct. 25, 2007.
Application No. 11/924,448 is a continuation-in-part of application No. 12/025,706, filed on Feb. 4, 2008.
Application No. 12/025,706 is a continuation-in-part of application No. 12/128,916, filed on May 29, 2008.
Application No. 12/128,916 is a continuation-in-part of application No. 11/309,594, filed on Aug. 28, 2006, now Pat. No. 7,383,362.
Application No. 11/309,594 is a continuation-in-part of application No. 12/186,471, filed on Aug. 5, 2008.

(51) Int. Cl. G06F 12/02; G06F 12/00

(52) U.S. Cl. 711/103; 711/202; 711/E12.001; 711/E12.002; 711/E12.008

(57) ABSTRACT

A hybrid solid-state disk (SSD) has multi-level-cell (MLC) or single-level-cell (SLC) flash memory, or both. SLC flash may be emulated by MLC that uses fewer cell states. A NVM controller converts logical block addresses (LBA) to physical block addresses (PBA). Most data is block-mapped and stored in MLC flash, but some critical or high-frequency data is page-mapped to reduce block-relocation copying. A hybrid mapping table has a first-level and a second level. Only the first level is used for block-mapped data, but both levels are used for page-mapped data. The first level contains a block-page bit that indicates if the data is block-mapped or page-mapped. A PBA field in the first-level table maps block-mapped data, while a virtual field points to the second-level table where the PBA and page number is stored for page-mapped data. Page-mapped data is identified by a frequency counter or sector count. SRAM space is reduced.

### RELATED APPLICATION

This application is a CIP of co-pending U.S. patent application for “Command Queuing Smart Storage Transfer Manager for Striping Data to Raw-NAND Flash Modules”, Ser. No. 12/252,155, filed Oct. 15, 2008.

This application is a continuation-in-part (CIP) of “Multi-Level Controller with Smart Storage Transfer Manager for Interleaving Multiple Single-Chip Flash Memory Devices”, U.S. Ser. No. 12/186,471, filed Aug. 5, 2008.

This application is a continuation-in-part (CIP) of co-pending U.S. patent application for “Single-Chip Multi-Media Card/Secure Digital controller Reading Power-on Boot Code from Integrated Flash Memory for User Storage”, Ser. No. 12/128,916, filed on May 29, 2008, which is a continuation of U.S. patent application for “Single-Chip Multi-Media Card/Secure Digital controller Reading Power-on Boot Code from Integrated Flash Memory for User Storage”, Ser. No. 11/309,594, filed on Aug. 28, 2006, now issued as U.S. Pat. No. 7,383,362, which is a CIP of U.S. patent application for “Single-Chip USB Controller Reading Power-On Boot Code from Integrated Flash Memory for User Storage”, Ser. No. 10/707,277, filed on Dec. 2, 2003, now issued as U.S. Pat. No. 7,103,684.

This application is also a CIP of co-pending U.S. patent application for “Reliability High Endurance Non-Volatile Memory Device with Zone-Based Non-Volatile Memory File System”, Ser. No. 12/101,877, filed Apr. 11, 2008.

This application is also a CIP of co-pending U.S. patent application for “Hybrid SSD Using a Combination of SLC and MLC Flash Memory Arrays”, U.S. application Ser. No. 11/926,743, filed Oct. 29, 2007.

This application is also a CIP of co-pending U.S. patent application for “Methods and systems of managing memory addresses in a large capacity multi-level cell (MLC) based flash memory device”, U.S. application Ser. No. 12/025,706, filed Feb. 4, 2008.

This application is also a CIP of co-pending U.S. patent application for “Portable Electronic Storage Devices with Hardware Security Based on Advanced Encryption Standard”, U.S. application Ser. No. 11/924,448, filed Oct. 25, 2007.

### FIELD OF THE INVENTION

This invention relates to flash-memory solid-state-drive (SSD) devices, and more particularly to hybrid mapping of single-level-cell (SLC) and multi-level-cell (MLC) flash systems.

### BACKGROUND OF THE INVENTION

Host systems such as Personal Computers (PC's) store large amounts of data in mass-storage devices such as hard disk drives (HDD). Mass-storage devices are sector-addressable rather than byte-addressable, since the smallest unit of flash memory that can be read or written is a page that is several 512-byte sectors in size. Flash memory is replacing hard disks and optical disks as the preferred mass-storage medium.

NAND flash memory is a type of flash memory constructed from electrically-erasable programmable read-only memory (EEPROM) cells, which have floating gate transistors. These cells use quantum-mechanical tunnel injection for writing and tunnel release for erasing. NAND flash is non-volatile so it is ideal for portable devices storing data. NAND flash tends to be denser and less expensive than NOR flash memory.

However, NAND flash has limitations. In the flash memory cells, the data is stored in binary terms—as ones (1) and zeros (0). One limitation of NAND flash is that when storing data (writing to flash), the flash can only write from ones (1) to zeros (0). When writing from zeros (0) to ones (1), the flash needs to be erased a “block” at a time. Although the smallest unit for read can be a byte or a word within a page, the smallest unit for erase is a block.

Single Level Cell (SLC) flash and Multi Level Cell (MLC) flash are two types of NAND flash. The erase block size of SLC flash may be 128 K+4 K bytes while the erase block size of MLC flash may be 256 K+8 K bytes. Another limitation is that NAND flash memory has a finite number of erase cycles between 10,000 and 100,000, after which the flash wears out and becomes unreliable.

Comparing MLC flash with SLC flash, MLC flash memory has advantages and disadvantages in consumer applications. In the cell technology, SLC flash stores a single bit of data per cell, whereas MLC flash stores two or more bits of data per cell. MLC flash can have twice or more the density of SLC flash with the same technology. But the performance, reliability and durability may decrease for MLC flash.

MLC flash has a higher storage density and is thus better for storing long sequences of data; yet the reliability of MLC is less than that of SLC flash. Data that is changed more frequently is better stored in SLC flash, since SLC is more reliable and rapidly-changing data is more likely to be critical data than slowly changing data. Also, smaller units of data may more easily be aggregated together into SLC than MLC, since SLC often has fewer restrictions on write sequences than does MLC.

A consumer may desire a large capacity flash-memory system, perhaps as a replacement for a hard disk. A solid-state disk (SSD) made from flash-memory chips has no moving parts and is thus more reliable than a rotating disk.

Several smaller flash drives could be connected together, such as by plugging many flash drives into a USB hub that is connected to one USB port on a host, but then these flash drives appear as separate drives to the host. For example, the host's operating system may assign each flash drive its own drive letter (D:, E:, F:, etc.) rather than aggregate them together as one logical drive, with one drive letter. A similar problem could occur with other bus protocols, such as Serial AT-Attachment (SATA), integrated device electronics (IDE), Serial small-computer system interface (SCSI) (SAS) bus, a fiber-channel bus, and Peripheral Components Interconnect Express (PCIe). The parent application, now U.S. Pat. No. 7,103,684, describes a single-chip controller that connects to several flash-memory mass-storage blocks.

Larger flash systems may use multiple channels to allow parallel access, improving performance. A wear-leveling algorithm allows the memory controller to remap logical addresses to any different physical addresses so that data writes can be evenly distributed. Thus the wear-leveling algorithm extends the endurance of the flash memory, especially MLC-type flash memory.

What is desired is a multi-channel flash system with flash memory on modules in each of the channels. It is desired to use both MLC and SLC flash memory in a hybrid system to maximize storage efficiency; however a MLC-only flash memory storage system with the hybrid mapping structure can also be benefit. A hybrid mapping structure is desirable to map logical addresses to physical blocks in both SLC and MLC flash memory. A hybrid mapping structure that also benefits SLC-only or MLC-only flash system is further desired. The hybrid mapping table can reduce the amount of costly SRAM required compared with an all-page-mapping method. It is further desired to allocate new host data to SLC flash when the data size is smaller and more likely to change, but to allocate new host data to MLC flash when the data is in a longer sequence and is less likely to be changed.

A smart storage switch is desired between the host and the multiple flash-memory modules so that data may be striped across the multiple channels. It is desired that the smart storage switch interleaves and stripes data accesses to the multiple channels of flash-memory devices.

### BRIEF DESCRIPTION OF THE DRAWINGS

FIG. 1 shows a smart storage switch using hybrid flash memory with multiple levels of controllers.

FIGS. 2A-C show cell states in SLC and MLC flash memory.

FIGS. 3A-C show a host system using flash modules.

FIGS. 4A-E show boards with flash memory.

FIGS. 5A-B show operation of multiple channels of NVMD.

FIGS. 6A-B highlight assigning host data to either SLC or MLC flash.

FIG. 7 is a flowchart of using a frequency counter to page-map and block-map host data to MLC and SLC flash memory.

FIG. 8 is a flowchart of using the sector count (SC) from the host command to page-map and block-map host data to MLC and SLC flash memory.

FIGS. 9A-E show a 2-level hybrid mapping table and use of a 1-level hybrid mapping table.

FIG. 10 shows and address space divided into districts.

FIGS. 11A-B show block-mode mapping within a district.

FIGS. 12A-B show block, zone, and page mapping using a 2-level hybrid mapping table.

FIGS. 13A-F are examples of host accesses of a hybrid-mapped flash-memory system using 2-level hybrid mapping tables.

FIGS. 14A-G show further examples of host accesses of a hybrid-mapped flash-memory system using 2-level hybrid mapping tables.

FIGS. 15A-B are flowcharts of using both the sector count (SC) and the frequency counter (FC) from the host command to page-map and block-map host data to MLC and SLC flash memory.

FIG. 16 is a flowchart of data re-ordering and striping for dispatch to multiple channels of Non-Volatile Memory Devices (NVMDs).

FIGS. 17A-B show sector data re-ordering, striping and dispatch to multiple channels of NVMD.

FIGS. 18A-B show sector data re-ordering, striping and dispatch to multiple wide channels of NVMD.

FIGS. 19A-C highlight data caching in a hybrid flash system.

### DETAILED DESCRIPTION

The present invention relates to an improvement in hybrid MLC/SLC flash systems. The following description is presented to enable one of ordinary skill in the art to make and use the invention as provided in the context of a particular application and its requirements. Various modifications to the preferred embodiment will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

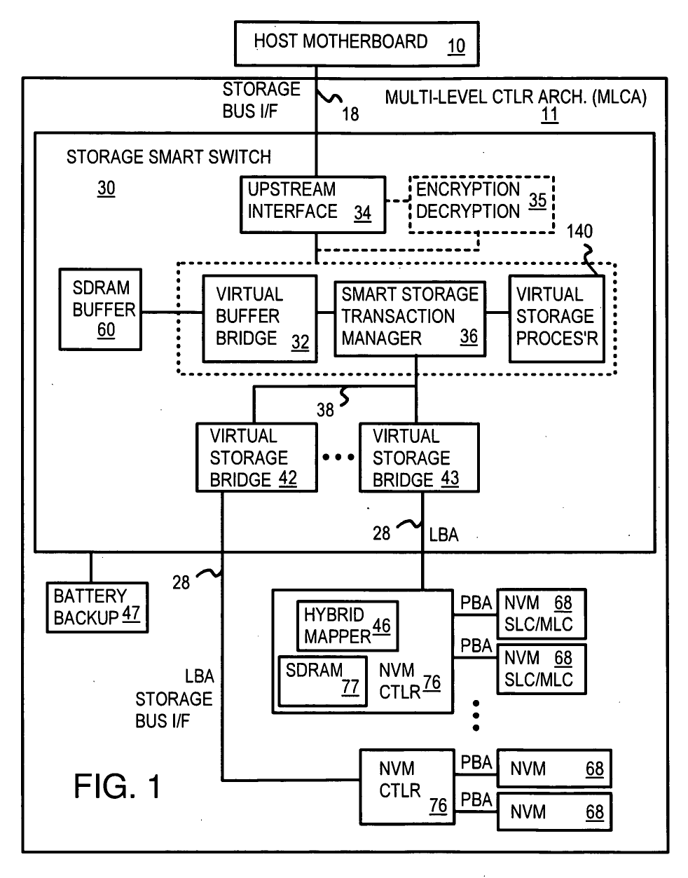

FIG. 1 shows a smart storage switch using hybrid flash memory with multiple levels of controllers. Smart storage switch 30 is part of multi-level controller architecture (MLCA) 11 and connects to host motherboard 10 over host storage bus 18 through upstream interface 34. Smart storage switch 30 also connects to downstream flash storage device over LBA storage bus interface 28 through virtual storage bridges 42, 43.

Virtual storage bridges 42, 43 are protocol bridges that also provide physical signaling, such as driving and receiving differential signals on any differential data lines of LBA storage bus interface 28, detecting or generating packet start or stop patterns, checking or generating checksums, and higher-level functions such as inserting or extracting device addresses and packet types and commands. The host address from host motherboard 10 contains a logical block address (LBA) that is sent over LBA storage bus interface 28, although this LBA may be stripped by smart storage switch 30 in some embodiments that perform ordering and distributing equal sized data to attached NVM flash memory 68 through NVM controller 76.

Buffers in SDRAM 60 coupled to virtual buffer bridge 32 can store the sector data when the host writes data to a MLCA disk, and temporally hold data while the host is fetching from flash memories. SDRAM 60 is a synchronous dynamic-random-access memory for smart storage switch 30. SDRAM 60 also can be used as temporary data storage or a cache for performing Write-Back, Write-Thru, or Read-Ahead Caching.

Virtual storage processor 140 provides striping services to smart storage transaction manager 36. For example, logical addresses from the host can be calculated and translated into logical block addresses (LBA) that are sent over LBA storage bus interface 28 to NVM flash memory 68 controlled by NVM controllers 76. Host data may be alternately assigned to flash memory in an interleaved fashion by virtual storage processor 140 or by smart storage transaction manager 36. NVM controller 76 may then perform a lower-level interleaving among NVM flash memory 68. Thus interleaving may be performed on two levels, both at a higher level by smart storage transaction manager 36 among two or more NVM controllers 76, and by each NVM controller 76 among NVM flash memory 68.

NVM controller 76 performs logical-to-physical remapping as part of a flash translation layer function, which converts LBA's received on LBA storage bus interface 28 to PBA's that address actual non-volatile memory blocks in NVM flash memory 68. NVM controller 76 may perform wear-leveling and bad-block remapping and other management functions at a lower level.

When operating in single-endpoint mode, smart storage transaction manager 36 not only buffers data using virtual buffer bridge 32, but can also re-order packets for transactions from the host. A transaction may have several packets, such as an initial command packet to start a memory read, a data packet from the memory device back to the host, and a handshake packet to end the transaction. Rather than have all packets for a first transaction complete before the next transaction begins, packets for the next transaction can be re-ordered by smart storage switch 30 and sent to NVM controller 76 before completion of the first transaction. This allows more time for memory access to occur for the next transaction. Transactions are thus overlapped by re-ordering packets.

Packets sent over LBA storage bus interface 28 are re-ordered relative to the packet order on host storage bus 18. Transaction manager 36 may overlap and interleave transactions to different NVM flash memory 68 controlled by NVM controllers 76, allowing for improved data throughput. For example, packets for several incoming host transactions are stored in SDRAM buffer 60 via virtual buffer bridge 32 or an associated buffer (not shown). Transaction manager 36 examines these buffered transactions and packets and re-orders the packets before sending them over internal bus 38 to virtual storage bridge 42, 43, then to one of the downstream flash storage blocks via NVM controllers 76.

A packet to begin a memory read of a flash block through bridge 43 may be re-ordered ahead of a packet ending a read of another flash block through bridge 42 to allow access to begin earlier for the second flash block.

Encryption and decryption of data may be performed by encryptor/decryptor 35 for data passing over host storage bus 18. Upstream interface 34 may be configured to divert data streams through encryptor/decryptor 35, which can be controlled by a software or hardware switch to enable or disable the function. This function can be an Advanced Encryption Standard (AES), IEEE 1667 standard, etc, which will authenticate the transient storage devices with the host system either through hardware or software programming. The methodology can be referenced to U.S. application Ser. No. 11/924,448, filed Oct. 25, 2007. Battery backup 47 can provide power to smart storage switch 30 when the primary power fails, allowing write data to be stored into flash. Thus a write-back caching scheme may be used with battery backup 47 rather than only a write-through scheme.

Hybrid mapper 46 in NVM controller 76 performs 1 level of mapping to NVM flash memory 68 that are MLC flash, or two levels of mapping to NVM flash memory 68 that are SLC flash. Data may be buffered in SDRAM 77 within NVM controller 76. Alternatively, NVM controller 76 and NVM flash memory 68 can be embedded with storage smart switch 30.

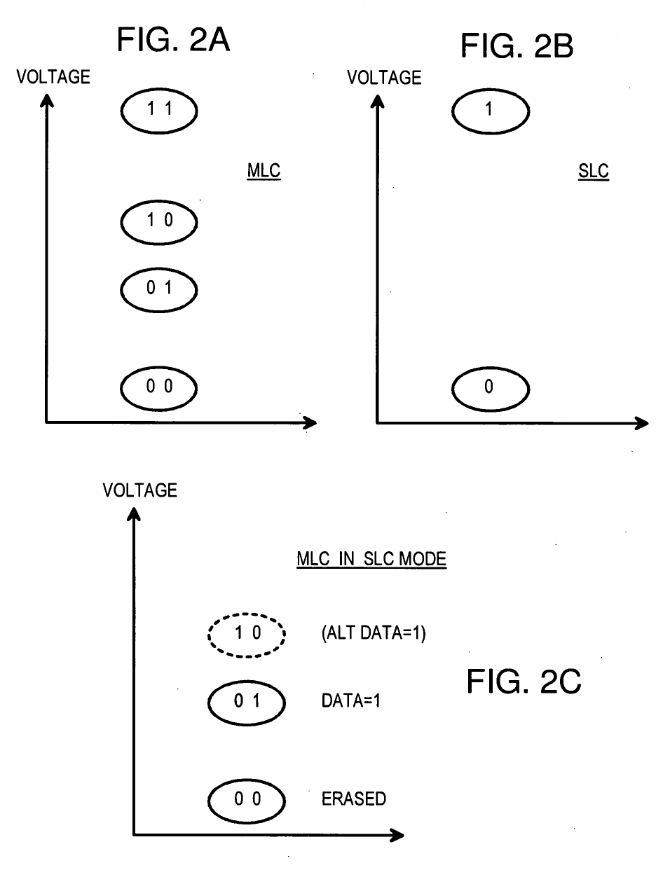

FIGS. 2A-C show cell states in SLC and MLC flash memory. In FIG. 2A, a MLC flash cell has 4 states that are distinguished by different voltages generated when reading or sensing the cell. An erased 00 state has the lowest read voltage, while a fully programmed 11 state generates the largest read voltage. Two intermediate states 01 and 10 produce intermediate read voltages. Thus two binary bits can be stored in one MLC cell that has four states. Note that the actual read voltages and logic values can differ, such as by using inverters to invert logical values.

In FIG. 2B, A SLC flash cell has only 2 states, 0 and 1. However, the read voltages between the 0 and 1 state are larger than the voltage difference between adjacent states for the MLC cell shown in FIG. 2A. Thus a better noise margin is provided by the SLC flash cell. The SLC cell is more reliable than the MLC cell, since a larger amount of charge stored in the SLC cell may leak off and still allow the correct state to be read. A less sensitive read sense circuit is needed to read the SLC cell than for the MLC cell.

In FIG. 2C, A MLC flash device is being operated in a SLC mode to emulate a SLC flash. Some MLC flash chips may provide a SLC mode, or may allow the number of bits stored per MLC cell to be specified by a system manufacturer. Alternately, a system manufacturer may intentionally control the data values being programmed into a MLC flash device so that the MLC device emulates a SLC flash device.

While the MLC device has four states shown in FIG. 2A, only two of the four states are used in SLC mode, as shown in FIG. 2C. The erased state 00 is used to emulate a SLC cell storing a 0 bit, while the 01 state is used to emulate a SLC cell storing a 1 bit. The 11 state is not used, since it requires a longer programming time than does the 01 state. The 10 state is not used.

Alternately, states 00 and 10 could be used, while states 01 and 11 are not used. State 00 emulates a SLC 0 bit, while state 10 emulates a SLC 1 bit. This may be done by programming either one page out of two pages shared by single MLC cell (sych as 00 to 01 state to improve programming time or 00 to 10 state to improve noise margin). Alternatively, both pages can be repeatedly programmed with same data bits (00 and 11 states used) to improve the data retention but sacrifice the programming time.

Thus a MLC flash device may be operated in such a way to emulate a SLC flash device. Data reliability is improved since fewer MLC states are used, and noise margins may be relaxed. A hybrid system may have both SLC and MLC flash devices, or it may have only MLC flash devices, but operate some of those MLC devices in a SLC-emulation mode. Data thought to be more critical may be stored in SLC, while less-critical data may be stored in MLC.

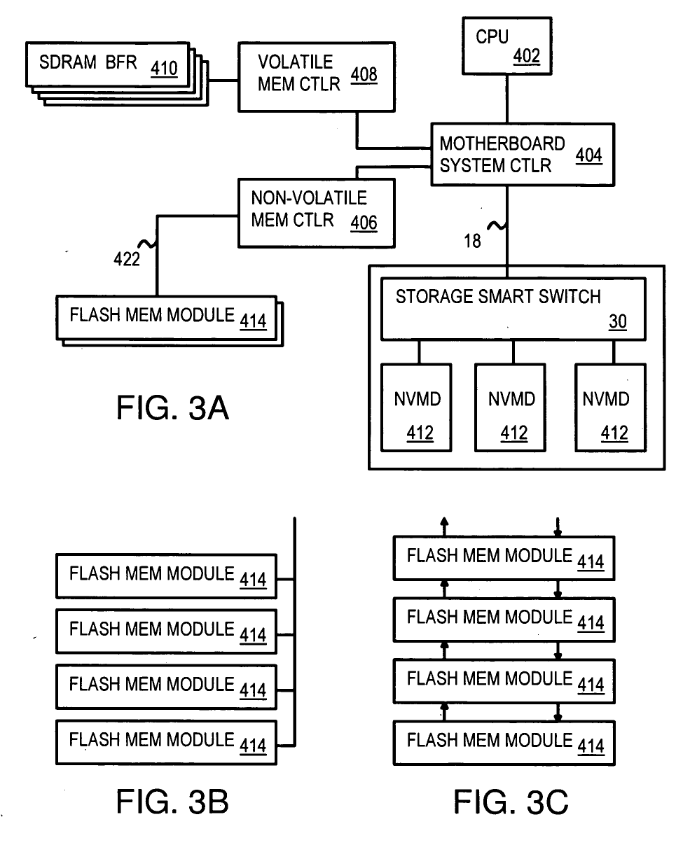

FIG. 3A shows a host system using flash modules. Motherboard system controller 404 connects to Central Processing Unit (CPU) 402 over a front-side bus or other high-speed CPU bus. CPU 402 reads and writes SDRAM buffer 410, which is controlled by volatile memory controller 408. SDRAM buffer 410 may have several memory modules of DRAM chips.

Data from flash memory may be transferred to SDRAM buffer 410 by motherboard system controller using both volatile memory controller 408 and non-volatile memory controller 406. A direct-memory access (DMA) controller may be used for these transfers, or CPU 402 may be used. Non-volatile memory controller 406 may read and write to flash memory modules 414. DAM may also access NVMD 412 which are controlled by smart storage switch 30.

NVMD 412 contain both NVM controller 76 and flash memory chips 68 as shown in FIG. 1. NVM controller 76 converts LBA to PBA addresses. Smart storage switch 30 sends logical LBA addresses to NVMD 412, while non-volatile memory controller 406 sends physical PBA addresses over physical bus 422 to flash modules 414. Physical bus 422 can carry LBA or PBA depending on the type of flash modules 414. A host system may have only one type of NVM sub-system, either flash modules 414 or NVMD 412, although both types could be present in some systems.

FIG. 3B shows that flash modules 414 of FIG. 3A may be arranged in parallel on a single segment of physical bus 422. FIG. 3C shows that flash modules 414 of FIG. 3A may be arranged in series on multiple segments of physical bus 422 that form a daisy chain.

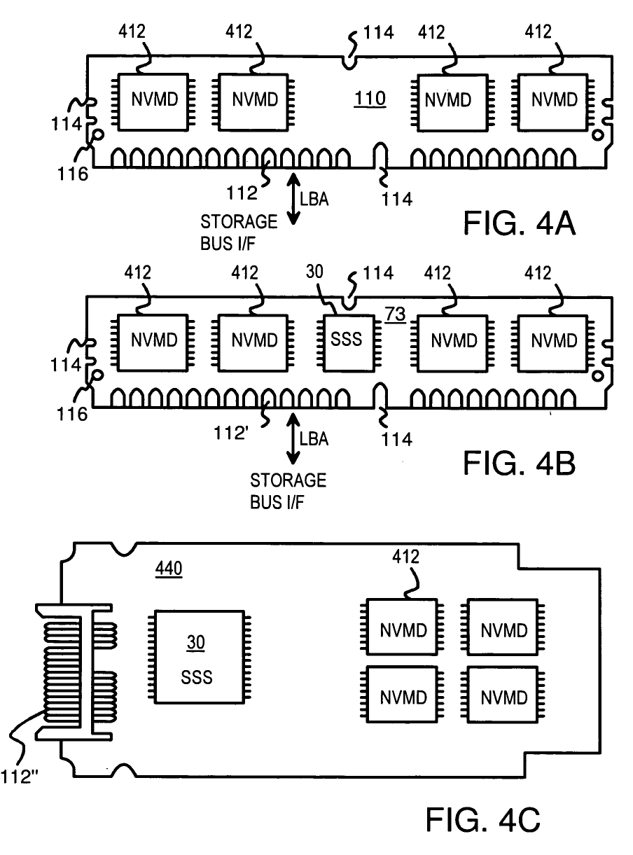

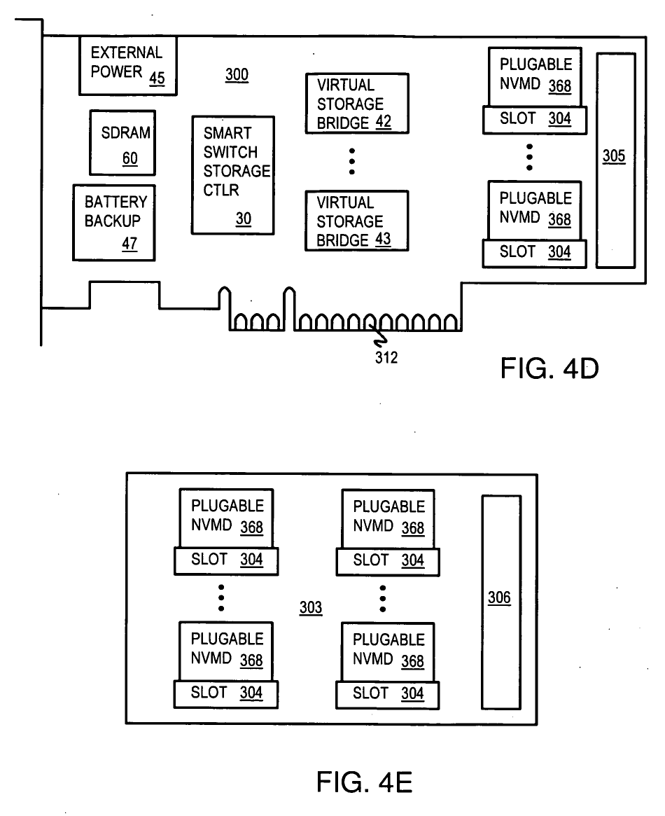

FIGS. 4A-D show boards with flash memory. These boards could be plug-in boards that fit into a slot, or could be integrated with the motherboard or with another board.

FIG. 4A shows a flash module. Flash module 110 contains a substrate such as a multi-layer printed-circuit board (PCB) with surface-mounted NVMD 412 mounted to the front surface or side of the substrate, as shown, while more NVMD 412 are mounted to the back side or surface of the substrate (not shown). Alternatively, NVMD 412 can use a socket or a connector instead of being directly surface-mounted.

Metal contact pads 112 are positioned along the bottom edge of the module on both front and back surfaces. Metal contact pads 112 mate with pads on a module socket to electrically connect the module to a PC motherboard. Holes 116 are present on some kinds of modules to ensure that the module is correctly positioned in the socket. Notches 114 also ensure correct insertion and alignment of the module. Notches 114 can prevent the wrong type of module from being inserted by mistake. Capacitors or other discrete components are surface-mounted on the substrate to filter noise from NVMD 412, which are also mounted using a surface-mount-technology SMT process.

Flash module 110 connects NVMD 412 to metal contact pads 112. The connection to flash module 110 is through a logical bus LBA or through LBA storage bus interface 28. Flash memory chips 68 and NVM controller 76 of FIG. 1 could be replaced by flash module 110 of FIG. 4A.

Metal contact pads 112 form a connection to a flash controller, such as non-volatile memory controller 406 in FIG. 3A. Metal contact pads 122 may form part of physical bus 422 of FIG. 3A. Metal contact pads 122 may alternately form part of LBA storage bus interface 28 of FIG. 1 to smart storage switch 30.

FIG. 4B shows a LBA flash module. Flash module 73 contains a substrate such as a multi-layer printed-circuit board (PCB) with surface-mounted NVMD 412 and smart storage switch 30 mounted to the front surface or side of the substrate, as shown, while more NVMD 412 are mounted to the back side or surface of the substrate (not shown).

Metal contact pads 112′ are positioned along the bottom edge of the module on both front and back surfaces. Metal contact pads 112′ mate with pads on a module socket to electrically connect the module to a PC motherboard. Holes 116 are present on some kinds of modules to ensure that the module is correctly positioned in the socket. Notches 114 also ensure correct insertion of the module. Capacitors or other discrete components are surface-mounted on the substrate to filter noise from NVMD 412 and smart storage switch 30.

Since flash module 73 has smart storage switch 30 mounted on it's substrate, NVMD 412 do not directly connect to metal contact pads 112′. Instead, NVMD 412 connect using wiring traces to smart storage switch 30, then smart storage switch 30 connects to metal contact pads 112′. The connection to flash module 73 is through a LBA storage bus interface 28 from controller 404, such as shown in FIG. 3A.

FIG. 4C shows a Solid-State-Disk (SSD) board that can connect directly to a host. SSD board 440 has a connector 112″ that plugs into a host motherboard, such as into host storage bus 18 of FIG. 1. Connector 112″ can carry a SATA, PATA, PCI Express, or other bus. NVMD 412 are soldered to SSD board 440. Other logic and buffers may be present. Smart storage switch 30 is shown in FIG. 1.

FIG. 4D shows a PCIe card with NVM flash memory. Connector 312 on PCIe card 300 is a x1, x2, x4, or x8 PCIe connector that is plugged into a PCIe bus. Smart storage switch controller 30 uses SDRAM 60 to buffer data. SDRAM 60 can be directly soldered to PCIe card 300 or a removable SDRAM module may be plugged into a module socket on PCIe card 300. Data is sent through virtual storage bridges 42, 43 to slots 304, which have pluggable Non-Volatile Memory Device (NVMD) 368 inserted. Pluggable NVMD 368 may contain NVMD 412. Power for pluggable NVMD 368 is provided through slot 304. Alternatively, NVMD 412 and related components can be physically mounted to the PCIe card 300 or connected through a cable. Connector 305 can accept a daughter card to expand the flash memory capacity.

Optional power connector 45 is located on PCIe card 300 to supply power for pluggable NVMD 368 and an expansion daughter card in case of the power from the connector 312 cannot provide enough power. Battery backup 47 can be soldered in or attached to PCIe card 300 to supply power to PCIe card 300, slots 304, and connector 305 in case of sudden power loss.

FIG. 4E shows an expansion daughter card. Connector 306 on expansion daughter card 303 can be plugged into connector 305 (FIG. 4D) its. Expansion daughter card 303 includes slots 304 and pluggable NVMD 368. Battery Backup 47 can be a module(s) providing power to all components on PCIe card 300 for power failure backup purpose, or it can be staggered to provide several outputs with on/off controllable capability, and provide power for each NVMD device when a chip enable activates a particular device. Each power output can control a portion of PCIe card 300 such as slots 304 and expansion connector 305. With this power staggering capability, battery backup 47 can improve efficiency and reduce peak power loading, which can save system cost and make system function more stable.

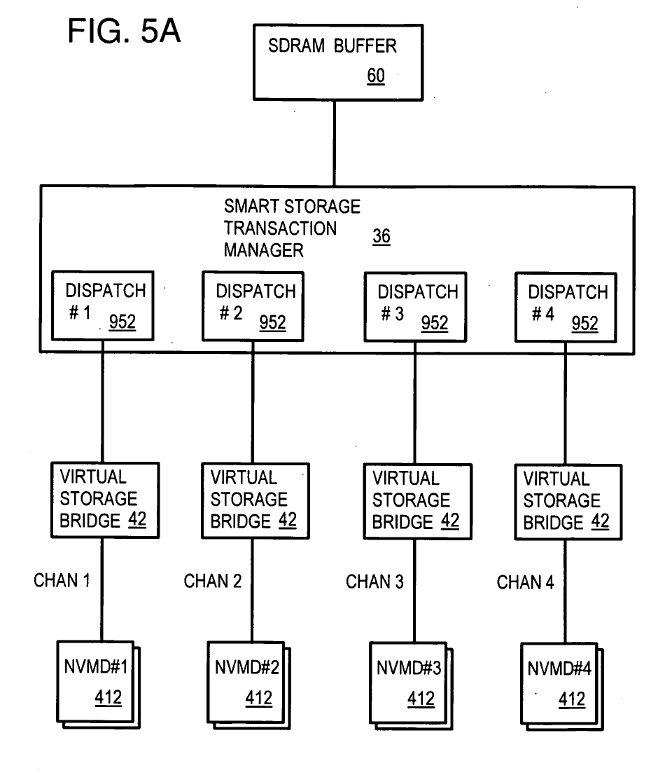

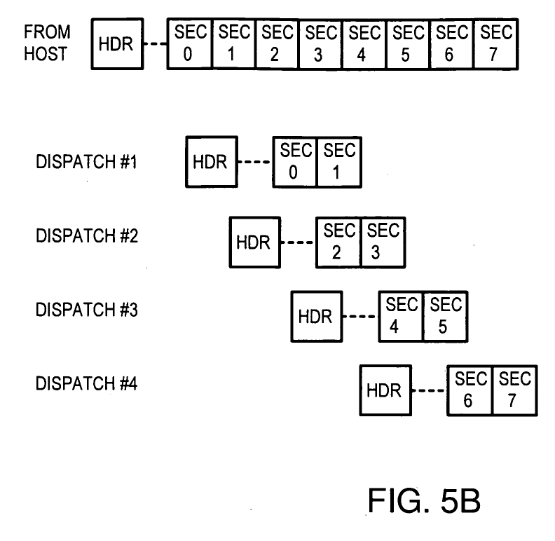

FIGS. 5A-B show operation of multiple channels of NVMD. In FIG. 5A, host data buffered by SDRAM 60 is written to flash memory by smart storage transaction manager 36, which moves the data to dispatch units 952. Each dispatch unit 952 drives data through virtual storage bridge 42 to one of four channels. Each channel has flash memory in NVMD 412. Since there are four channels, four flash memory devices may be written to at the same time, improving performance.

In FIG. 5B, host data has a header HDR and 8 sectors of data. Smart storage transaction manager 36 assigns two sectors to each of the four channels. The header is replicated and sent to each of the four channels, followed by two sectors of data for each channel. The host header may be altered somewhat by smart storage transaction manager 36 before being sent to the channels.

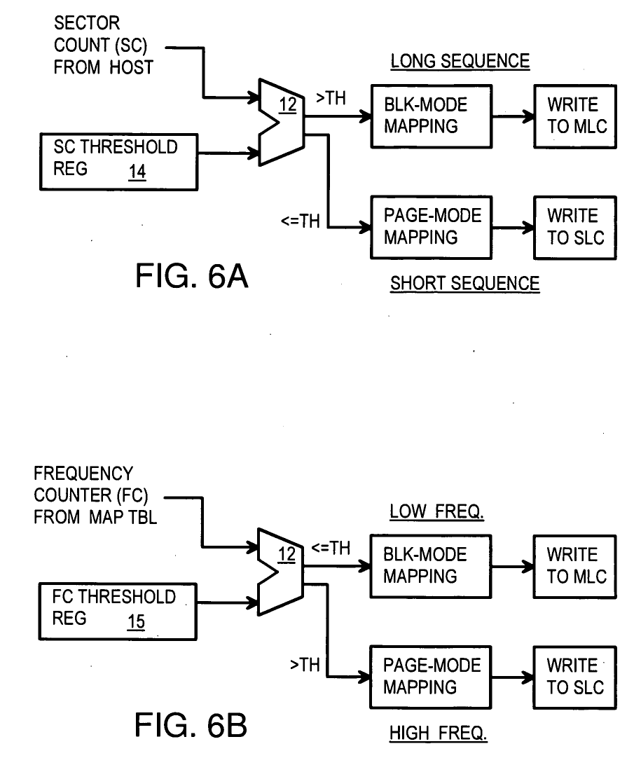

FIGS. 6A-B highlight assigning host data to either SLC or MLC flash. The first method in FIG. 6A uses the sector count (SC) from the host to decide whether to use SLC or MLC flash. A threshold can be programmed into register 14, such as 4 sectors. Comparator 12 compares the sector count (SC) from the host to the threshold SC in register 14. When the host SC is greater than the threshold SC, block-mode mapping is used for this data, and the data is written to MLC flash. The data is assumed to be less critical or less likely to be changed in the future when the SC is large. For example, user data such as songs or videos are often long sequences of data with many sectors and thus a larger SC.

When the host SC is less than or equal to the threshold SC, page-mode mapping is used for this data, and the data is written to SLC flash. The data is assumed to be more critical or more likely to be changed in the future when the SC is small. For example, critical system files such as directories of files may change just a few entries and this have a small sector count. Also, small pieces of data have a small sector count, and may be stored with other unrelated data when packed into a larger block. Using SLC better allows for such packing by the Smart storage switch.

Since there are many pages in a block, page-mode mapping provides a finer granularity than does block-mode mapping. Thus critical, small data is page-mapped into more reliable SLC flash memory, while less-critical and long sequences of data is block-mapped into cheaper, denser MLC flash memory. Long sequences of data (large SC) are block-mapped into MLC, while short data sequences (small SC) are page-mapped into SLC.

In FIG. 6B, a frequency counter (FC) determines when to page-map data into SLC. A frequency counter (FC) is stored for each entry in the mapping table. Initially, data is block-mapped to MLC. The FC for that data is updated each time the data is accessed. On subsequent data accesses, the stored FC is compared to a threshold FC in register 15 by comparator 12. When the stored FC is less than or equal to the FC threshold, the data continues to be block mapped and stored in MLC.

However, when the stored FC exceeds the threshold in register 15, the data is moved to SLC and the block-mapped entry is replaced with a page-mapped entry. Thus frequently-accessed data is eventually moved to SLC flash. This method is more precise than that of FIG. 6A, since access frequency is measured rather than guessed from the host's sector count. The frequency counter could be incremented for each write, or for either writes or reads, and these counters could be cleared periodically or managed in some other way.

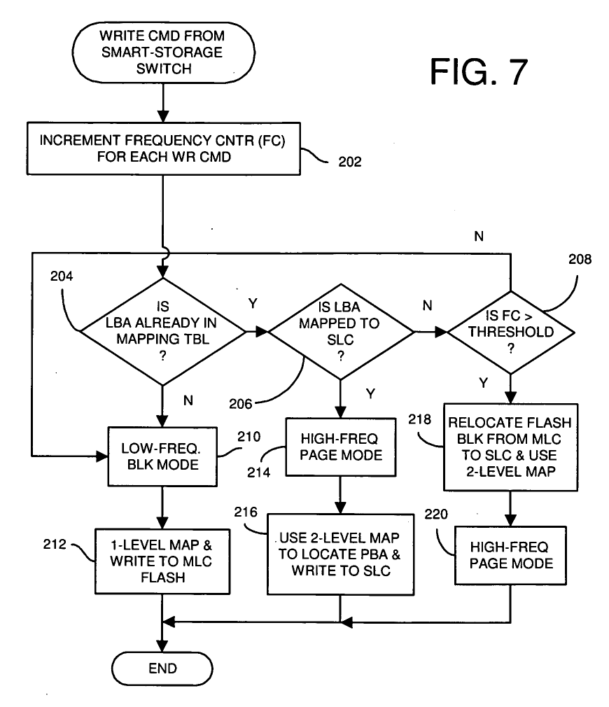

FIG. 7 is a flowchart of using a frequency counter to page-map and block-map host data to MLC and SLC flash memory. This method is highlighted in FIG. 6B. A host write command is passed through smart storage switch 30 to the NVM controller 76 (FIG. 1), which has hybrid mapper 77 that executes the routine of FIG. 7. The frequency counter (FC) is incremented for write commands, step 202. When no existing entry is found in the mapping tables, step 204, block mode is initially selected for this new data, step 210. A block entry is loaded into the top-level mapping table, step 212, and the data is written to MLC flash memory.

When an existing entry is found in the mapping tables, step 204, and the mapping entry indicates that this data is mapped to a SLC flash memory, step 206, then page mode is selected, step 214, and the 2-level mapping tables are used to find the physical-block address (PBA) to write the data to in MLC flash memory, step 216.

When an existing entry is found in the mapping tables, step 204, and the mapping entry indicates that this data is mapped to a MLC flash memory, step 206, then the frequency counter (FC) is examined, step 208. When the FC is less than the FC threshold, step 208, then block mode is selected for this new data, step 210. The data is written to MLC flash, step 212 and a 1-level mapping entry is used.

When the FC exceeds the FC threshold, step 208, then page mode is selected for this new data, step 220. The data for this block is relocated from MLC flash memory to SLC flash memory, and a new entry loaded into two levels of the mapping table, step 218. The data is now accessible and mapable in page units rather than in the larger block units.

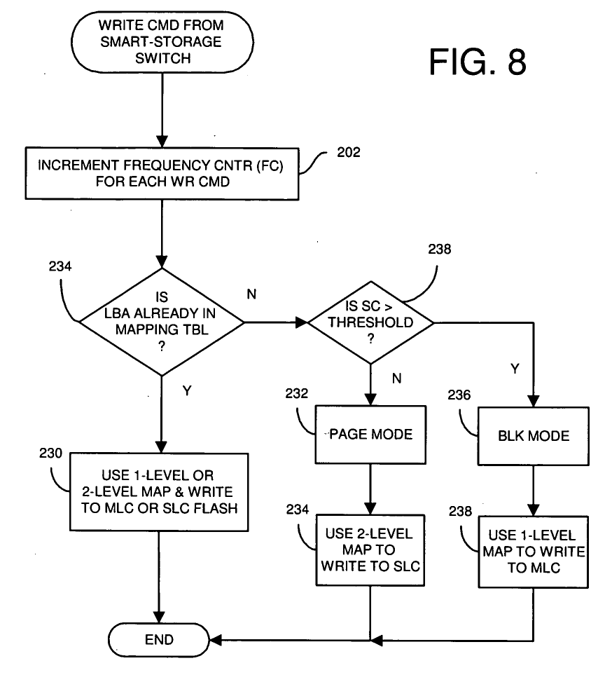

FIG. 8 is a flowchart of using the sector count (SC) from the host command to page-map and block-map host data to MLC and SLC flash memory.

A host write command is passed through smart storage switch 30 to the NVM controller 76 (FIG. 1), which has hybrid mapper 77 that executes the routine of FIG. 8. The frequency counter (FC) is incremented for write commands, step 202. When no existing entry is found in the mapping tables, step 234, the sector count (SC) in the host command is used to select either page-mode or block mode. When the sector count exceeds the threshold SC, step 238, block mode is selected for this new data, step 236. A block entry is loaded into the top-level mapping table, step 238, and the data is written to MLC flash memory.

When the sector count does not exceed the threshold SC, step 238, page mode is selected for this new data, step 232. A 2-level page entry is loaded into the mapping table, step 234, and the data is written to SLC flash memory.

When an existing entry is found in the mapping tables, step 234, the mapping tables are read for the host's LBA, and the method already indicated in the mapping tables is used to select either page-mode or block mode, step 230. The data is written to SLC flash if earlier data was written to SLC flash, while the data is written to MLC if earlier data was written to MLC, as indicated by the existing mapping-table entry.

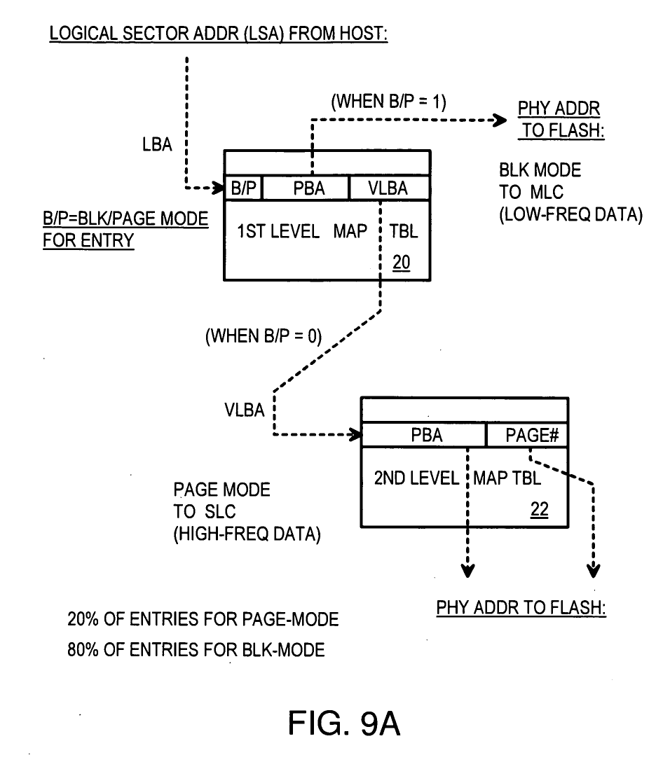

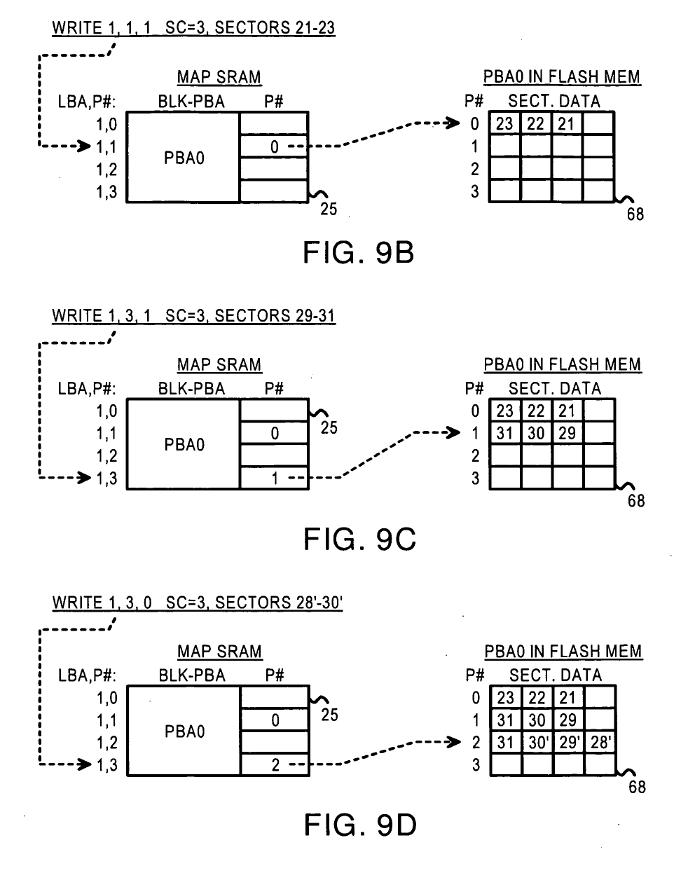

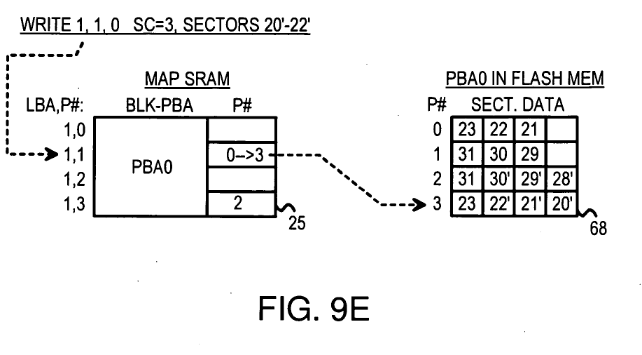

FIG. 9A shows a 2-level hybrid mapping table. The hybrid mapping table can have a ratio between Block-based and Page-based blocks such as 20% of total volume for a page-based mapping table and 80% for a block-based mapping table. A logical-block address (LBA) is extracted from the logical-sector address (LSA) from the host. A Page Offset (PO) and Sector Offset (SO) are also extracted from the LSA. The LBA selects an entry in first-level mapping table 20. The selected entry has a block/page (B/P) bit that is set to indicate that the entry is block-mode or cleared to indicate page-mode.

When the selected entry has B/P set, block mode is indicated, and the physical-block address (PBA) is read from this entry in first-level mapping table 20. The PBA points to a whole physical block in MLC flash memory.

When the selected entry has B/P cleared, page mode is indicated. A virtual LBA (VLBA) in a range of 0 to the maximum allocated block number assigned sequentially from 0 for page mode is read from the selected entry in first-level mapping table 20. Each VLBA has its own second-level mapping table 22. This VLBA together with a page offset (PO) from the LSA points to an entry in second-level mapping table 22. The content pointed to by the entry in second-level mapping table 22 contains the physical-block address (PBA), which is newly assigned from one of available empty blocks with the smallest wear-leveling count, and a page number. The PBA and page number are read from this entry in second-level mapping table 22. The PBA points to a whole physical block in SLC flash memory while the page number selects a page within that block. The page number is newly assigned from the blank page having the minimum page number in the PBA. The page number in the content pointed to by the entry may be different from the PO from LSA.

The granularity of each entry in second-level mapping table 22 maps just one page of data, while the granularity of each entry in first-level mapping table 20 maps a whole block of data pool. Since there may be 4, 8, 16, 128, 256, or some other number of pages per block, there are many entries in second-level mapping table 22 needed to completely map a block that is in page mode. However, only one entry in first-level mapping table 20 is needed for a whole block of data pool. Thus block mode uses the storage space of SRAM for mapping tables 20, 22 much more efficiently than does page mode.

If unlimited memory were available for mapping tables 20, 22, all data could be page mapped. However, entries for first-level mapping table 20 and second-level mapping table 22 are stored in SRAM in NVM controller 76, or smart storage switch 30. The storage space available for mapping entries is thus limited. The hybrid mapping system allocates only about 20% of the entries for use as page entries in second-level mapping table 22, while 80% of the entries are block entries in first-level mapping table 20. Thus storage required for the mapping tables is only about 20% (compared to page-based mapping table) while providing the benefit of page-granularity mapping for more critical data. This flexible hybrid mapping approach is storage-efficient yet provides the benefit of page-based mapping where needed.

FIGS. 9B-E shows an example of using a one-level hybrid mapping table 25. In this example, each logical block will have associated page entries to record the PBA and new mapped page location. In FIG. 9B, the first transaction starts to store the first page at address 0 since PBA 0 is all empty. In FIG. 9C, the second transaction, the logical page address is 3, and maps to physical page 1 following page 0 since both transactions' LBN is 01. In FIG. 9D, the third transaction starts storing physical page 2, but keeps old sector 31 which is already stored in page 0. In FIG. 9E, the fourth transaction also saves sector address 23, but leaves sectors 20, 21, 22 updated to reflect the newest sector data.

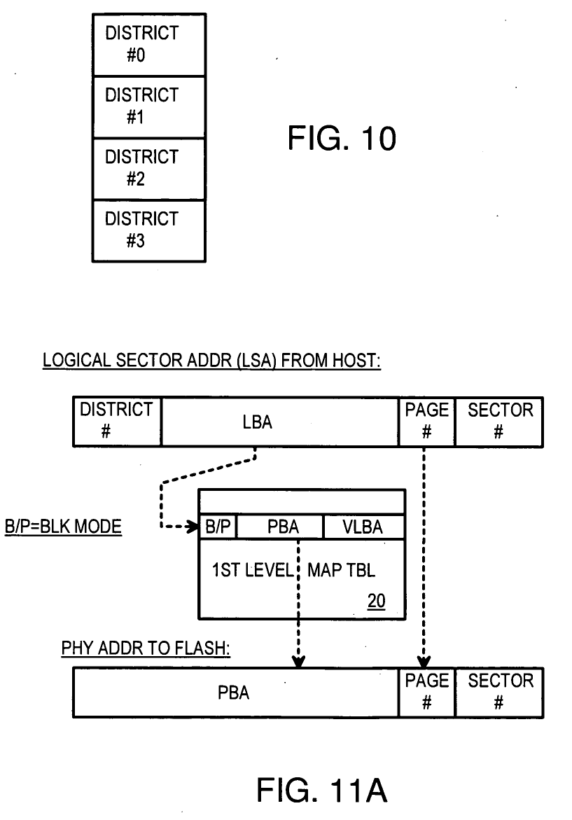

FIG. 10 shows and address space divided into districts. A large address space, such as that provided by high-density flash memory, may be divided into districts. Each district may be a large amount of memory, such as 4 GB. The upper-most address bits may be used to select the district.

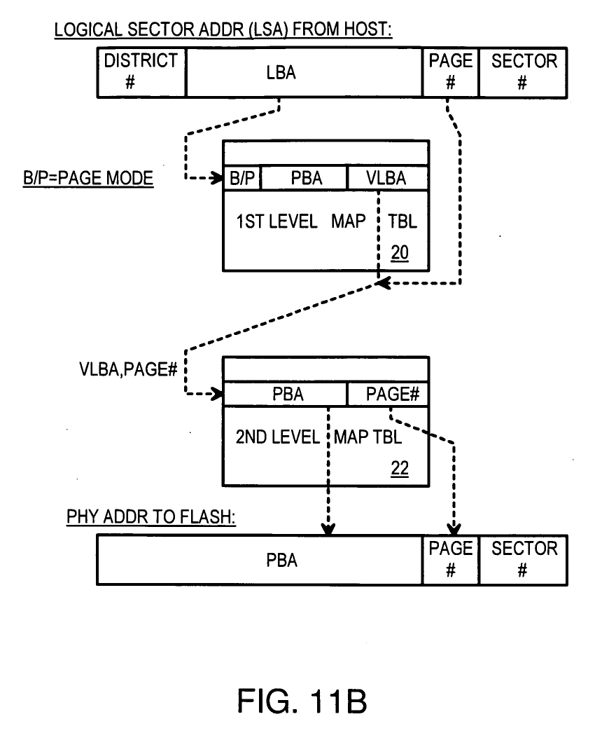

FIG. 11A shows block-mode mapping within a district. The upper bits of the logical-sector address (LSA) from the host select the district. All of the entries in first-level mapping table 20 are for the same district. When the district number changes and no longer matches the district number of the entries in first-level mapping table 20, all entries in first-level mapping table 20 are purged and flushed back to storage in flash memory, and new entries for the new district are fetched from flash memory and stored in first-level mapping table 20.

When the district number from the LSA matches the district number of all the entries in first-level mapping table 20, the LBA from the LSA selects an entry in first-level mapping table 20. When B/P indicates Block mode, the PBA is read from this selected entry and forms part of the physical address, along with the page number and sector numbers from the LSA. The PBA may have more address bits than the LBA, allowing the district to be mapped to any part of the physical flash memory.

In FIG. 11B, the B/P bit in the selected entry in first-level mapping table 20 indicates page mode. The VLBA from the selected entry is read from first-level mapping table 20 and is combined with the page number from the host LSA to locate an entry in second-level mapping table 22.

The PBA and the physical page number are read from this selected entry in second-level mapping table 22 and forms part of the physical address, along with the sector number from the LSA. Thus both the block and the page are remapped using two levels of mapping tables 20, 22.

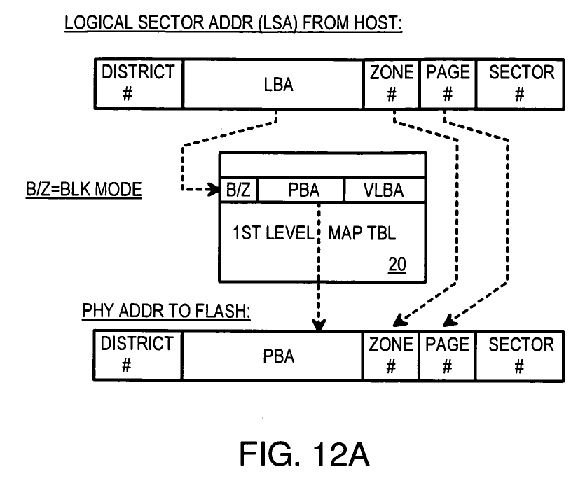

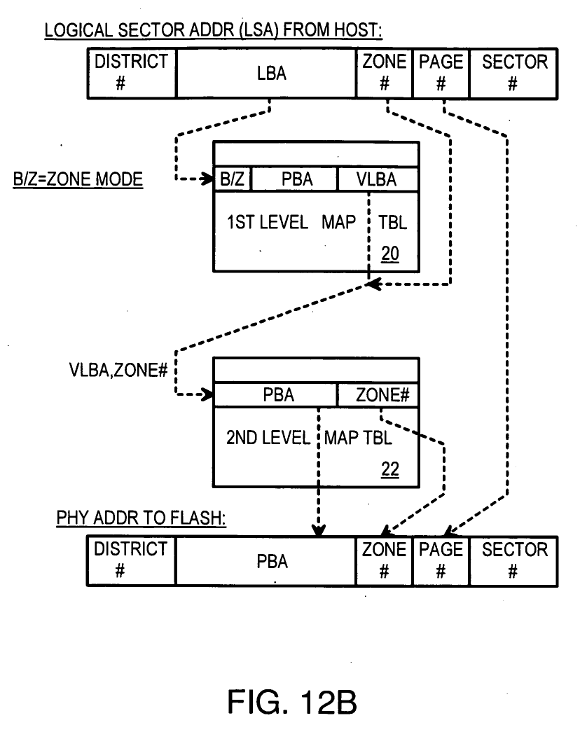

FIGS. 12A-B show block, zone, and page mapping using a 2-level hybrid mapping table. Each block is divided into multi-page zones. For example, a block may have 16 pages and 4 zones, with 4 pages per zone. The second level of mapping by second-level mapping table 22 is for zones rather than for individual pages in this alternative embodiment. Alternatively, in a special case, there can be one page per zone as shown in FIGS. 11A-B.

In FIG. 12A, the upper bits of the logical-sector address (LSA) from the host select the district. All of the entries in first-level mapping table 20 are for the same district. When the district number from the LSA matches the district number of all the entries in first-level mapping table 20, the LBA from the LSA selects an entry in first-level mapping table 20. When B/Z indicates Block mode, the PBA is read from this selected entry and forms part of the physical address, along with the zone number, page number and sector numbers from the LSA. Alternatively, avoid use of second-level mapping table 22 can save SRAM space in NVM controller 76.

In FIG. 12B, the B/Z bit in the selected entry in first-level mapping table 20 indicates zone mode. The VLBA from the selected entry is read from first-level mapping table 20 and is combined with the zone number from the host LSA to locate an entry in second-level mapping table 22.

The PBA and the physical zone number are read from this selected entry in second-level mapping table 22 and form part of the physical address, along with the page number and sector number from the LSA. Thus both the block and the zone are remapped using two levels of mapping tables 20, 22. Fewer mapping entries are needed with zone-mode than for page-mode, since each zone is multiple pages.

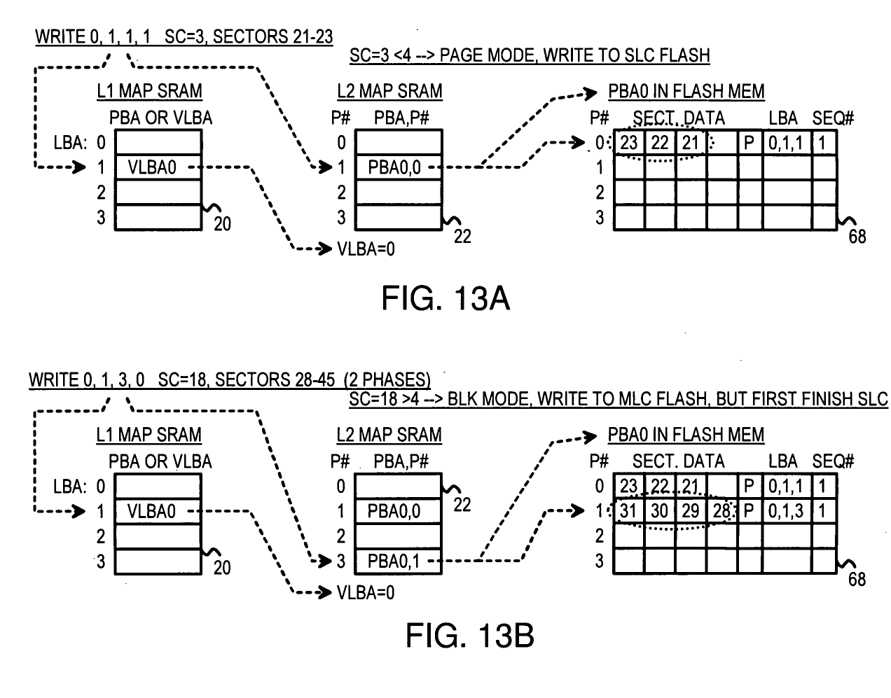

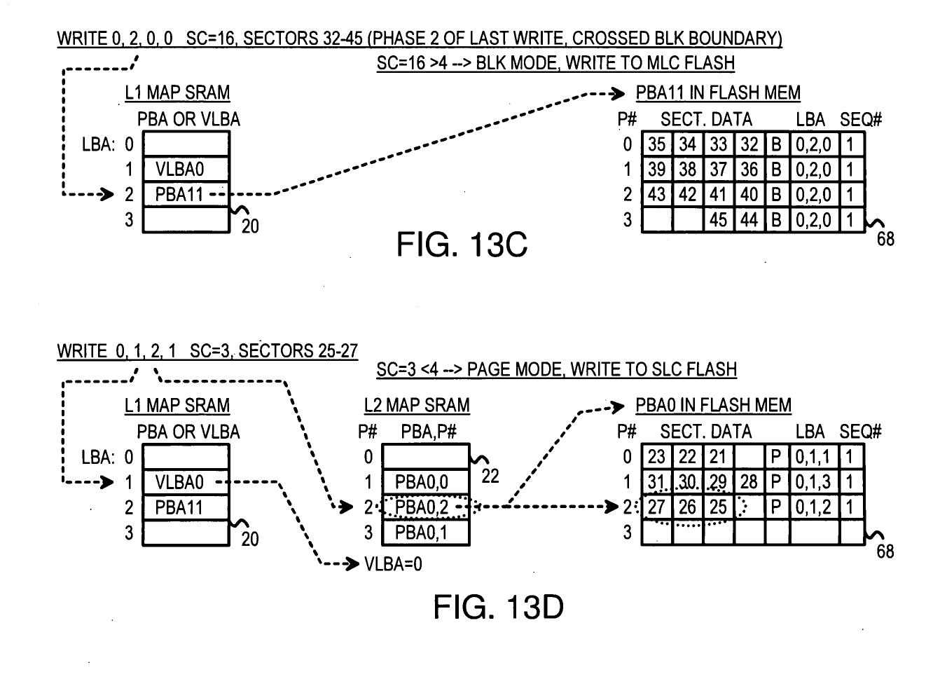

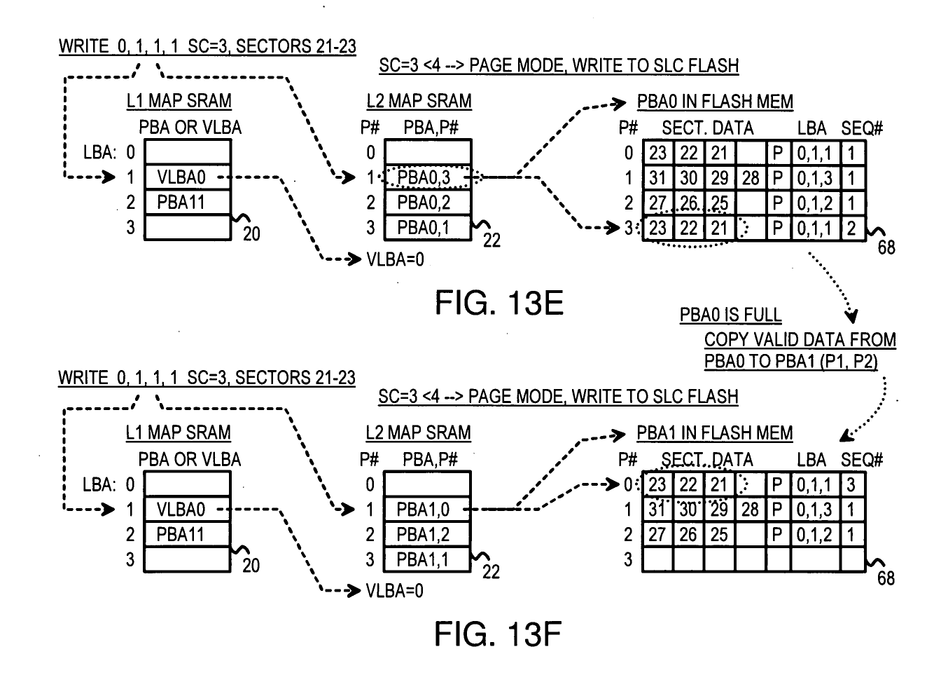

FIGS. 13A-F are examples of host accesses of a hybrid-mapped flash-memory system using 2-level hybrid mapping tables. Host addresses in thee examples are indicated as four values D, B, P, S, where D is the district, B is the block, P is the page, and S is the sector. In FIG. 13A, the host writes to 0, 1, 1, 1, which is district 0, logical block 1, page 1, and sector 1. This host address corresponds to sector 21, when there are four sectors per page, and four pages per block. The sector count SC is 3, so sectors 21-23 are written.

LBA32 1 from the host LSA selects entry 1 in first-level mapping table 20. Since the sector count SC is less than the threshold of 4, page mode is selected. VLBA0 is read from this selected entry and selects a table of entries in second-level mapping table 22. The page number from the host LSA (=1) selects page 1 in this second level table, and PBA=0 is read from the entry to locate the physical block PBA0 in NVM flash memory 68. The page number stored in the selected entry in second-level mapping table 22 selects the page in PBA0, page P0. The sector data from the host is written to the second, third, and fourth sectors in page P0 of block PBA0 and shown as sectors 21, 22, 23 in FIG. 13A. The district #, LBA #, and page # from the host's LSA is also written into the spare area of this entry in NVM flash memory 68, along with a sequence # and the block/page bit set to P for page mode.

In FIG. 13B, the host writes to LSA=0, 1, 3, 0, with a sector count SC of 18. Since the sector count exceeds the threshold of 4, block mode is selected. Sectors 28-45 are being written by the host. The same entry in first-level mapping table 20 is selected as in FIG. 13A, entry LBA1. The virtual LBA, VLBA0 is read and locates a portion of second-level mapping table 22. The page # from the host LSA is 3 and selects entry P3 in second-level mapping table 22. Sectors 28-31 from the host are in the same block as sectors 21-23 of the prior write performed in FIG. 13A, so these sectors 28-31 are written to the same physical block PBA0, but to the next page P1. PBA0, P1 are stored in the entry P3 of second-level mapping table 22 for sectors 28-31. The LSA of 0,1,3 is written to the spare area, and the mode is set to page mode since other parts of this block (sectors 21-23) are already page-mapped.

In FIG. 13C, the remaining sectors 32-45 are in the next block and cross the block boundary. The LSA for these sectors is 0,2,0,0 since sector 32 has this address. A different entry in first-level mapping table 20 is selected by LBA=2. Since SC=18 and is larger than the threshold, block mode is selected, and the entry in first-level mapping table 20 is tagged as a block-mode entry. PBA11 is loaded into first-level mapping table 20 and points to PBA11 in NVM flash memory 68. Sectors 32-45 are then written into several pages in this block PBA11. The B/P bits are set to B for block mode, and the LSA of 0,2,0 is also written to the spare areas. Note that the sector # from the LSA is not needed when the sectors are mapped to their same location in the logical and physical memory spaces.

While sectors 28-31 were written to SLC flash, sectors 31-45 were written to MLC flash. The host write of sectors 28-45 was performed in two phases shown in FIGS. 13B-C.

In FIG. 13D, the host writes sectors 25-27 to address 0, 1, 2, 1. The sector count is 3, which is less than the threshold and page mode is selected. LBA=1 selects entry LBA1 in first-level mapping table 20, which has VLBA0 that points to second-level mapping table 22. The logical page P2 selects entry P2 in second-level mapping table 22. Since there are more empty pages in PBA0, page P2 is selected to receive sectors 25-27, and PBA0, P2 are written to entry P2 in second-level mapping table 22. The spare area is updated with the LSA, page mode, and sequence number.

In FIG. 13E, the host over-writes sectors 21-23 at address 0, 1, 1, 1. The sector count is 3, which is less than the threshold and page mode is selected. LBA=1 selects the existing entry LBA1 in first-level mapping table 20, which has VLBA0 that points to second-level mapping table 22. The logical page P1 selects the existing entry P1 in second-level mapping table 22. Since there are more empty pages in PBA0, empty page P3 is selected to receive new sectors 21-23. Page P0 still holds the old data for these sectors 21-23; however this data is stale. The new data for sectors 21-23 are written to page P3, and entry PI in second-level mapping table 22 is changed from PBA0, P0 to PBA0, P3 to point to the fresh data in page 3 rather than the stale data in page 0. The sequence number increases to 2 for page P3 to show that P3 has fresher data than P0, which has a sequence number of 1.

In FIG. 13F, the host again over-writes sectors 21-23 at address 0, 1, 1, 1. However, PBA0 is full—there are no more empty pages in PBA0. The old data in PBA0 is copied to a new physical block, PBA1, and the entries in second-level mapping table 22 are changed from pointing to PBA0 to now point to PBA1. Pages P0 and P3 with the stale data sectors 21-23 are not copied, and their entries in second-level mapping table 22 are removed and left blank.

Empty page P0 is selected to receive new sectors 21-23. The new data for sectors 21-23 are written to page P0, and entry PI in second-level mapping table 22 is loaded with PBA1, P0 to point to the fresh data in page 0. The sequence number increases to 3.

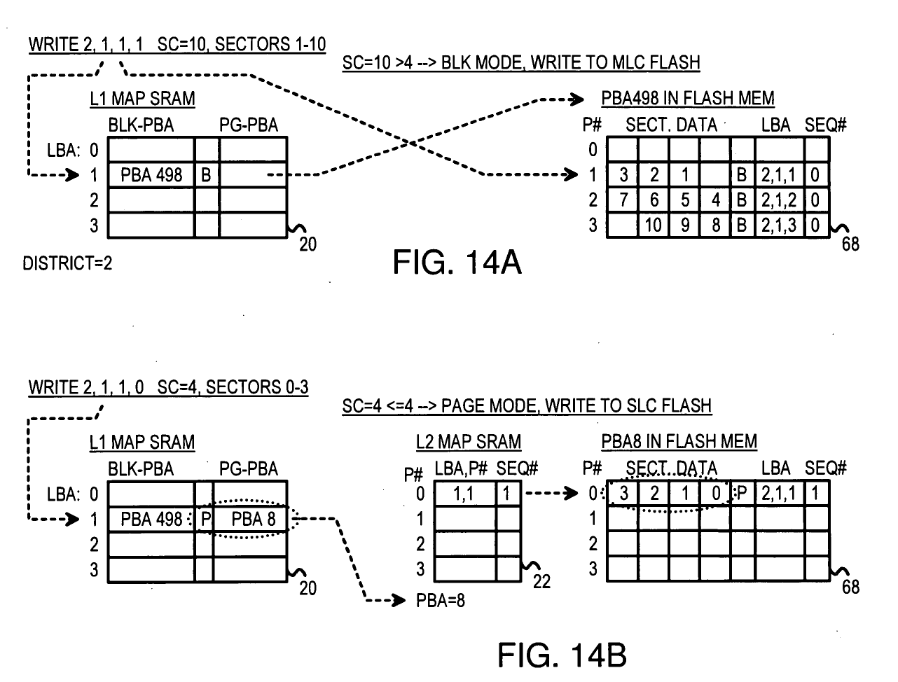

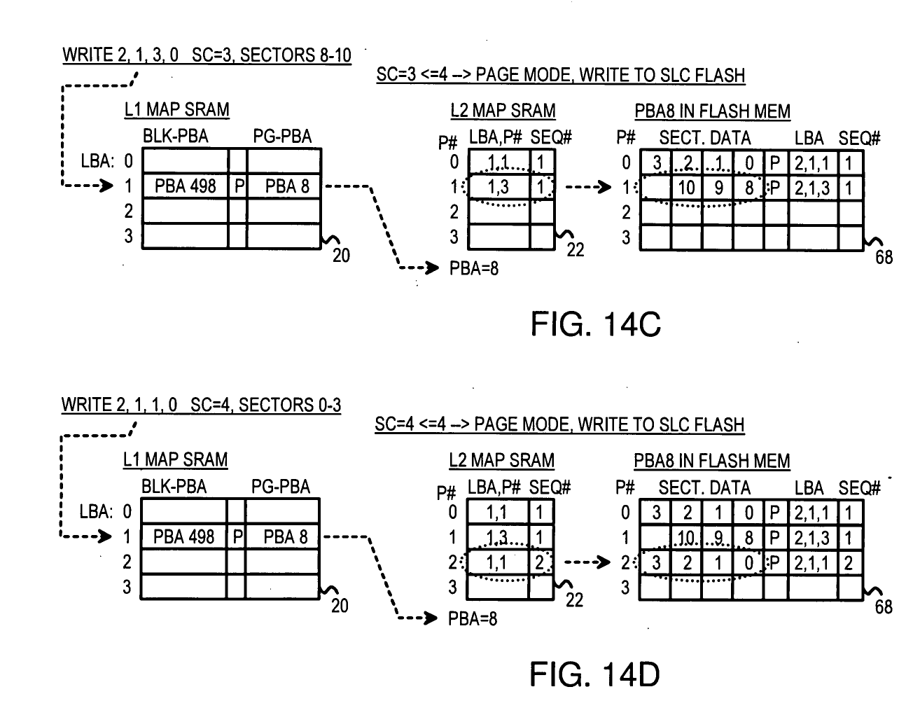

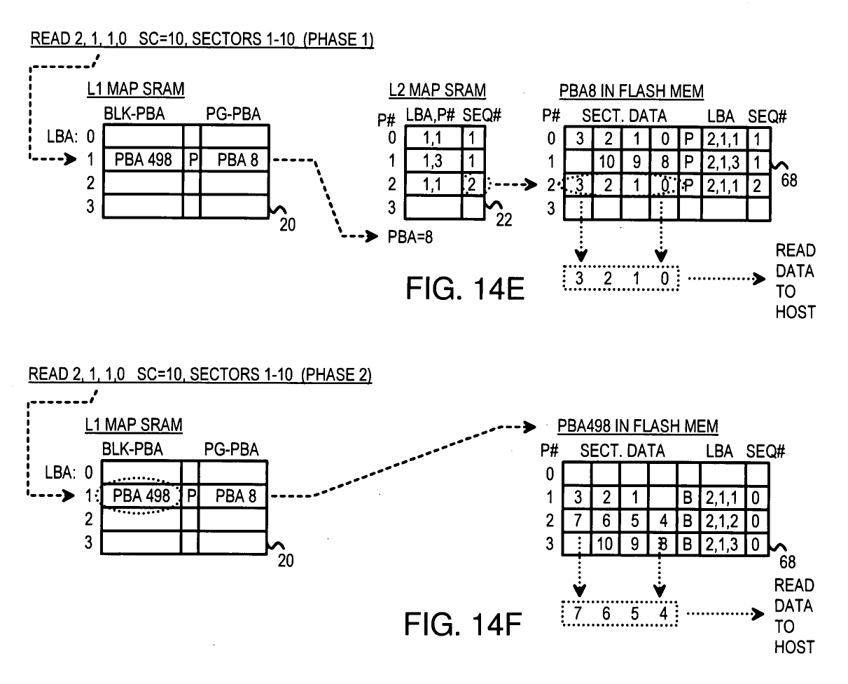

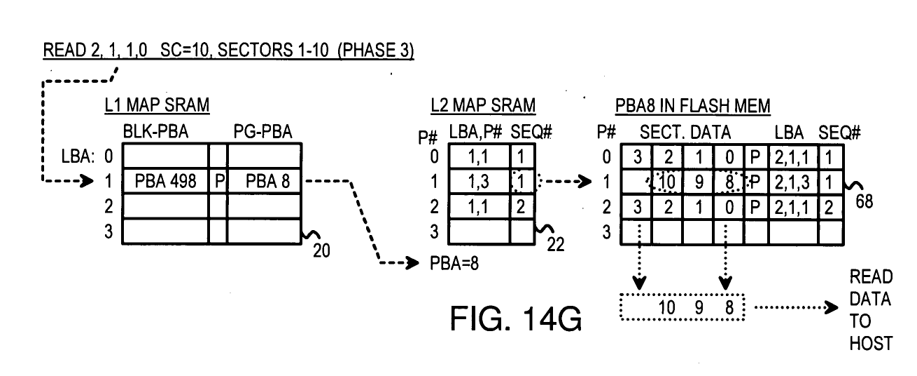

FIGS. 14A-G show further examples of host accesses of a hybrid-mapped flash-memory system using 2-level hybrid mapping tables. In these examples, the sequence number is also stored in second-level mapping table 22, and the page number of the entry in second-level mapping table 22 is the same as the page number of the sector data in NVM flash memory 68.

In FIG. 14A, the host writes to 2, 1, 1, 1 with a sector count SC of 10, corresponding to sectors 1-10. Since SC=0 is greater than the SC threshold of 4, block mode is selected. MLC flash is selected rather than SLC flash.

The mapping tables are already loaded for district 2; however, no entries exist for LBA=1. LBA=1 selects entry LBA1 in first-level mapping table 20, which is initially empty. A new empty physical block is found, such as from a pool of empty blocks, with PBA498 selected. The address of PBA498 is written to entry LBA1 in first-level mapping table 20, and the block bit B is set to indicate it is in block mode, since SC is larger than the threshold. Sectors 1-10 of host data are written to pages 1, 2, 3 of PBA498, as FIG. 14A shows, and the spare areas are written with the LBA, B/P bit, and sequence number. The sequence number is used to indicate the relative order or timing sequence for each identical page write, so the mapping table can be rebuilt if necessary.

In FIG. 14B, the host writes to 2, 1, 1, 0 with a sector count SC of 4, corresponding to sectors 0-3. Since SC=4 is equal to the SC threshold of 4, page mode is selected. The pool of SLC flash is selected rather than MLC flash.

The mapping tables are already loaded with an entry for LBA=1. A new empty physical block is found for storing second-level mapping table 22 and the sector data, PBA8, from the pool of empty SLC blocks. The address of PBA8 is written to the page-PBA field (VLBA field in FIG. 11) for entry LBA1 in first-level mapping table 20, and the block bit B is cleared to P for page mode indication.

The first page in PBA8 is selected to receive the sector data, and sectors 0-3 of host data are written to page 0 of PBA8, and the spare area of PBA8 page 0 is written with the LBA, B/P bit, and sequence number. The page 0 entry in second-level mapping table 22 is also written with the LBA and sequence number. Second-level mapping table 22 is stored in SRAM but corresponds to the same page in NVM flash memory 68. Pages in page mode are sequentially addressed and programmed. The sequence number is incremented to 1 since this is a previous page-hit case in block mode for block PBA498.

In FIG. 14C, the host writes to 2, 1, 3, 0 with a sector count SC of 3, corresponding to sectors 8-10. Since SC=3 is less than the SC threshold of 4, page mode is selected. The SLC flash pool is selected rather than MLC flash.

The mapping tables are already loaded with an entry for LBA=1. The page-mode bit P is set for this entry, so PBA8 is selected and locates entries in second-level mapping table 22 for PBA8. The next empty page entry in second-level mapping table 22 is selected, page P1, and loaded with the LBA and sequence number. Sectors 8-10 of host data are written to page 1 of PBA8, and the spare area is written with the LBA, B/P bit, and sequence number. The sequence number is also incremented since a hit case happens compared to the contents of PBA498 page 3.

In FIG. 14D, the host writes to 2, 1, 1, 0 with a sector count SC of 4, corresponding to sectors 0-3. Page mode and the SLC flash pool are selected.

The mapping tables are already loaded with an entry for LBA=1. The page-mode bit P is set for this entry, so PBA8 is selected and locates entries in second-level mapping table 22 for PBA8. The next empty page entry in second-level mapping table 22 is selected, page P2, and loaded with the LBA and sequence number. Sectors 0-3 of host data are written to page 2 of PBA8, and the spare area is written with the LBA, B/P bit, and sequence number, which is incremented to show that the data in page 0 is stale, since the level-2 mapping table with the previous entry 1,1 has already been occupied.

In FIG. 14E, the host reads from 2, 1, 1, 0 with a sector count SC of 10, corresponding to sectors 1-10. The mapping tables are already loaded with an entry for LBA=1. The page-mode bit P is set for this entry, so PBA8 is selected and locates entries in second-level mapping table 22 for PBA8. The page with the highest sequence number, page 2, is selected, rather than page 0. Sectors 0-3 are read from page 2 of PBA8 in NVM flash memory 68 and sent to the host.

In FIG. 14F, the second phase of the read occurs. Data sectors 4-10 are not found in any pages pointed to by the entries in second-level mapping table 22. Instead, the entry in first-level mapping table 20 is read, and the block-mode PBA is read, PBA498. Block PBA498 is read from NVM flash memory 68, and page 2 contains sectors 4-7, which are read and sent to the host.

In FIG. 14G, the third phase of the read occurs. Data sectors 8-10 are found in both PBA498 and PBA8. However, the data in PBA498 is stale, since it has a lower sequence number than the data in PBA8.

Entry LBA1 in first-level mapping table 20 is read, and PBA8 points to second-level mapping table 22. The entries in second-level mapping table 22 are examined and entry P1 is found that stores data for logical page 3. The sequence number in entry P1 in second-level mapping table 22 is 1, which is larger than the sequence number of 0 for these same sectors in PBA498. Sectors 8-10 are read from page 1 of PBA8 in NVM flash memory 68 and sent to the host.

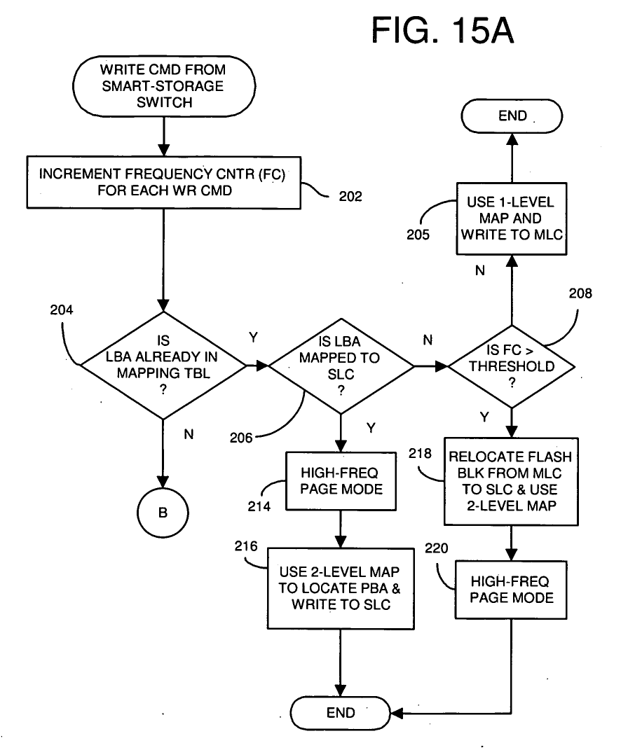

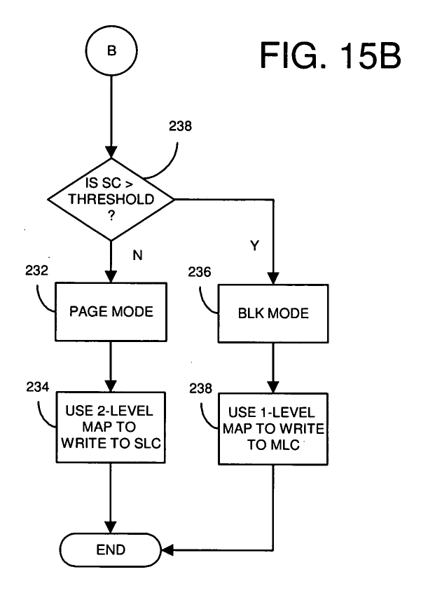

FIGS. 15A-B are flowcharts of using both the sector count (SC) and the frequency counter (FC) from the host command to page-map and block-map host data to MLC and SLC flash memory. This method is a combination of the two methods highlighted in FIGS. 6A-B and FIGS. 7-8.

A host write command is passed through smart storage switch 30 to the NVM controller 76 (FIG. 1), which has hybrid mapper 77 that executes the routine of FIG. 7. The frequency counter (FC) is incremented for write commands, step 202.

When an existing entry is found in the mapping tables, step 204, and the mapping entry indicates that this data is mapped to a SLC flash memory, step 206, then page mode is selected, step 214, and the 2-level mapping tables are used to find the physical-block address (PBA) to write the data to in SLC flash memory, step 216.

When an existing entry is found in the mapping tables, step 204, and the mapping entry indicates that this data is mapped to a MLC flash memory, step 206, then the frequency counter (FC) is examined, step 208. When the FC is less than the FC threshold, step 208, then block mode remains selected for this new data. The data is written to MLC flash, step 205 using the existing 1-level mapping entry.

When the FC exceeds the FC threshold, step 208, then page mode is selected for this new data, step 220. The data for this block is relocated from MLC flash memory to SLC flash memory, and a new entry loaded into two levels of the mapping table, step 218. The data is now accessible and mapable in page units rather than in the larger block units.

When an existing entry is not found in the mapping tables, step 204, and SC is greater than the SC threshold, step 238, then block mode is selected, step 236, for this new data. The data is written to MLC flash, step 238 using the 1-level mapping entry. When an existing entry is not found in the mapping tables, step 204, and SC is smaller than the SC threshold, step 238, then page mode is selected, step 232, for this new data. The data is written to SLC flash, step 234 using the 2-level mapping entry.

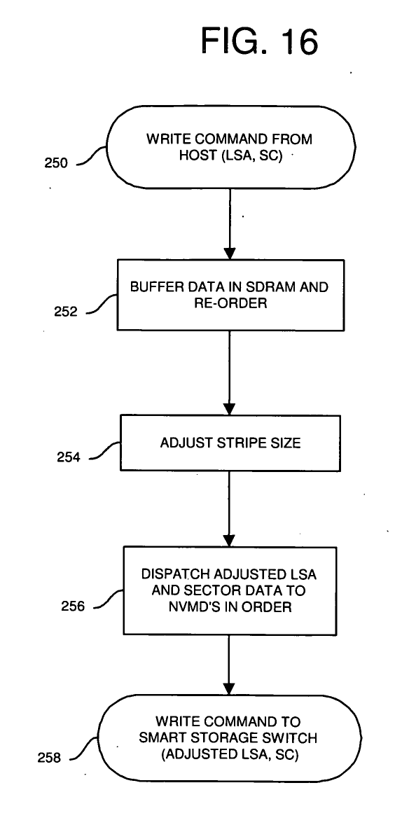

FIG. 16 is a flowchart of data re-ordering and striping for dispatch to multiple channels of Non-Volatile Memory Devices (NVMDs). The write command from the host has a LSA and a sector count (SC), step 250. The sector data from the host is written into SDRAM 60 for buffering. The sector data in the SDRAM buffer is then re-ordered, step 252. The stripe size may be adjusted, step 254, before the re-ordered data is read from the SDRAM buffer and dispatched to multiple NVMD in multiple channels, step 256.

The starting address from the host is adjusted for each dispatch to NVMD. Multiple commands are then dispatched from smart storage switch 30 to NVM controllers 76, step 258.

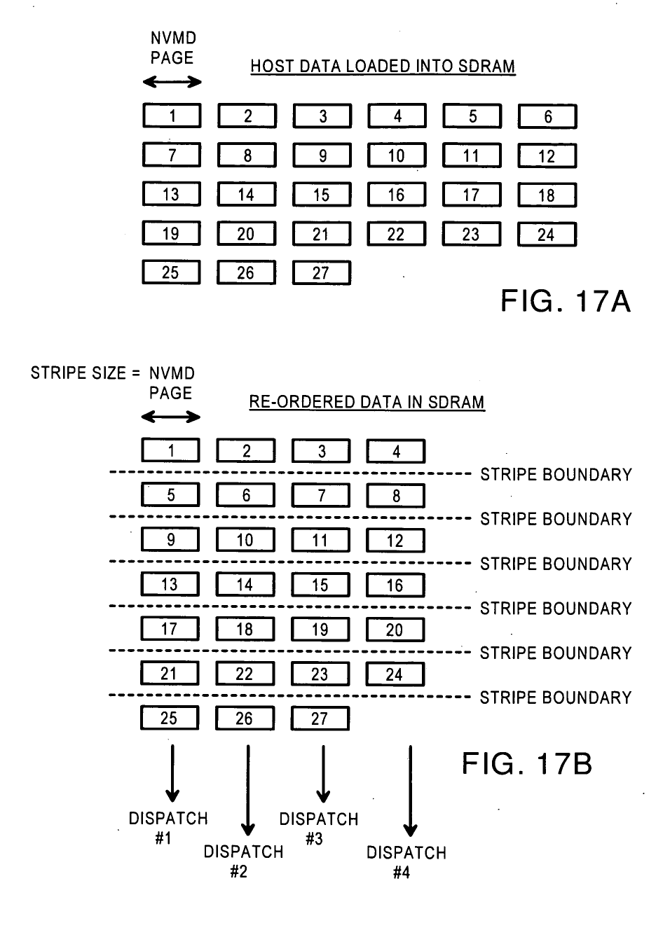

FIGS. 17A-B show sector data re-ordering, striping and dispatch to multiple channels of NVMD. FIG. 17A shows data from the host that is stored in SDRAM 60. The host data is written into SDRAM in page order. The stripe size is the same as the page size of the NVMD in this example.

In FIG. 17B, the data in SDRAM 60 has been re-ordered for dispatch to the multiple channels of NVMD. In this example there are four channels of NVMD, and each channel can accept one page at a time. The data is re-arranged to be four pages wide with four columns, and each one of the four columns is dispatched to a different channel of NVMD. Thus pages 1, 5, 9, 13, 17, 21, 25 are dispatched to the first NVMD channel, pages 2, 6, 10, 14, 18, 22, 26 are dispatched to the second NVMD channel, pages 3, 7, 11, 15, 19, 23, 27 are dispatched to the third NVMD channel, and pages 4, 8, 12, 16, 20, 24 are dispatched to the fourth NVMD channel.

A modified header and page 1 are first dispatched to NVMD 1, then another header and page 2 are dispatched to NVMD 2, then another header and page 3 are dispatched to NVMD 3, then another header and page 4 are dispatched to NVMD 4. This is the first stripe. Then another header and page 5 are dispatched to NVMD 1, another header and page 6 are dispatched to NVMD 2, etc. The stripe size may be optimized so that each NVMD is able to read or write near their maximum rate.

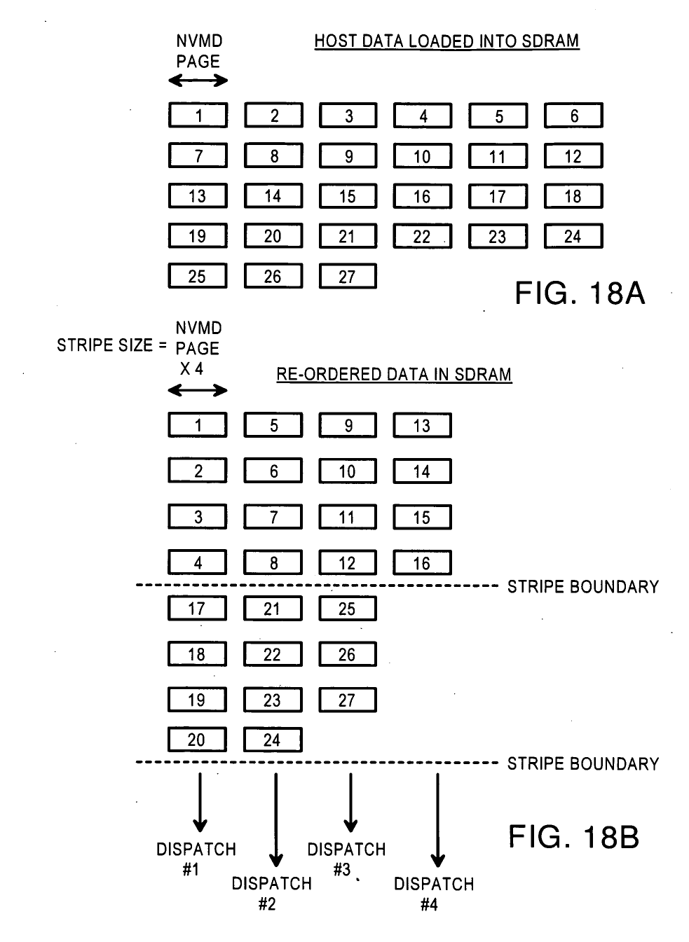

FIGS. 18A-B show sector data re-ordering, striping and dispatch to multiple wide channels of NVMD. FIG. 18A shows data from the host that is stored in SDRAM 60. The host data is written into SDRAM in page order. The stripe size is four times the page size of the NVMD in this example.

In FIG. 18B, the data in SDRAM 60 has been re-ordered for dispatch to the multiple channels of NVMD. In this example there are four channels of NVMD, and each channel can accept four pages at a time. The data is re-arranged to be four pages wide with four columns, and four pages from each one of the four columns is dispatched to a different channel of NVMD for each stripe. Thus pages 1, 2, 3, 4 are dispatched to the first NVMD channel, pages 5, 6, 7, 8 are dispatched to the second NVMD channel, pages 9, 10, 11, 12 are dispatched to the third NVMD channel, and pages 13, 14, 15, 16 are dispatched to the fourth NVMD channel. Then pages 17, 18, 19, 20 are dispatched to the first NVMD channel, pages 21, 22, 23, 24 are dispatched to the second NVMD channel, and pages 25, 26, 27 are finally dispatched to the third channel.

A modified header and four pages are dispatched together to each channel. The stripe boundary is at 4×4 or 16 pages.

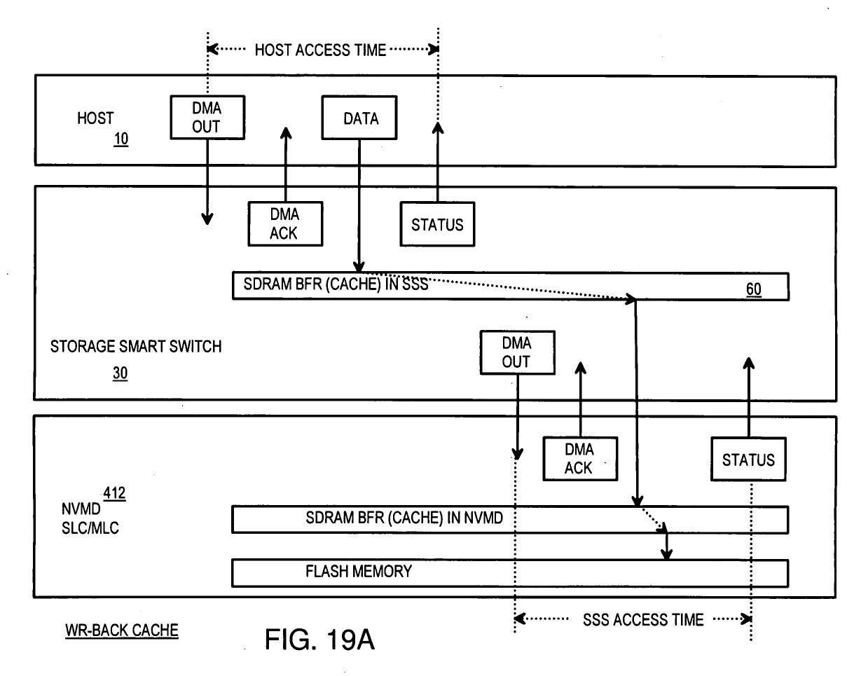

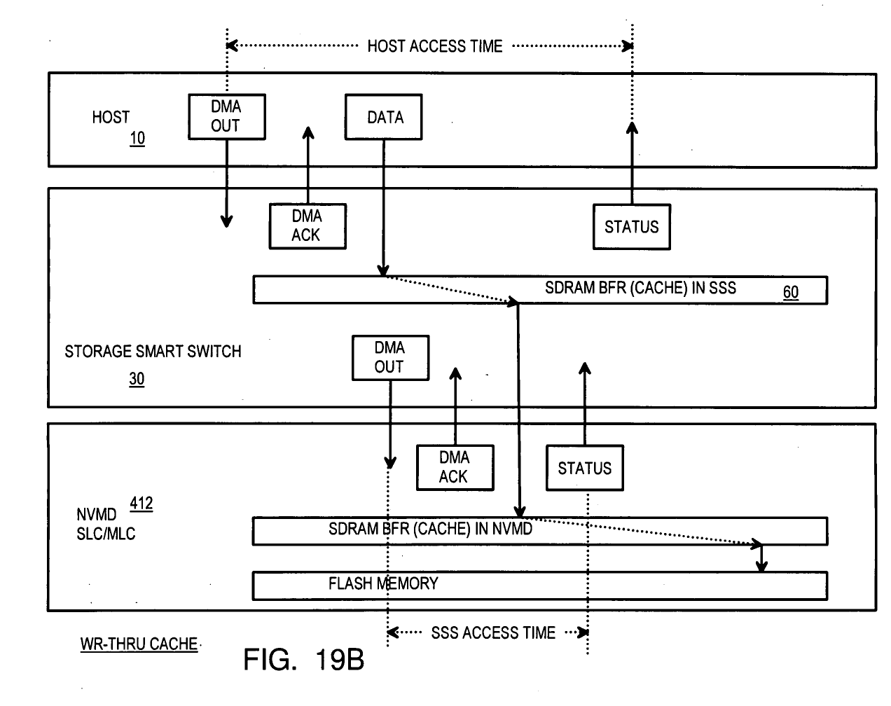

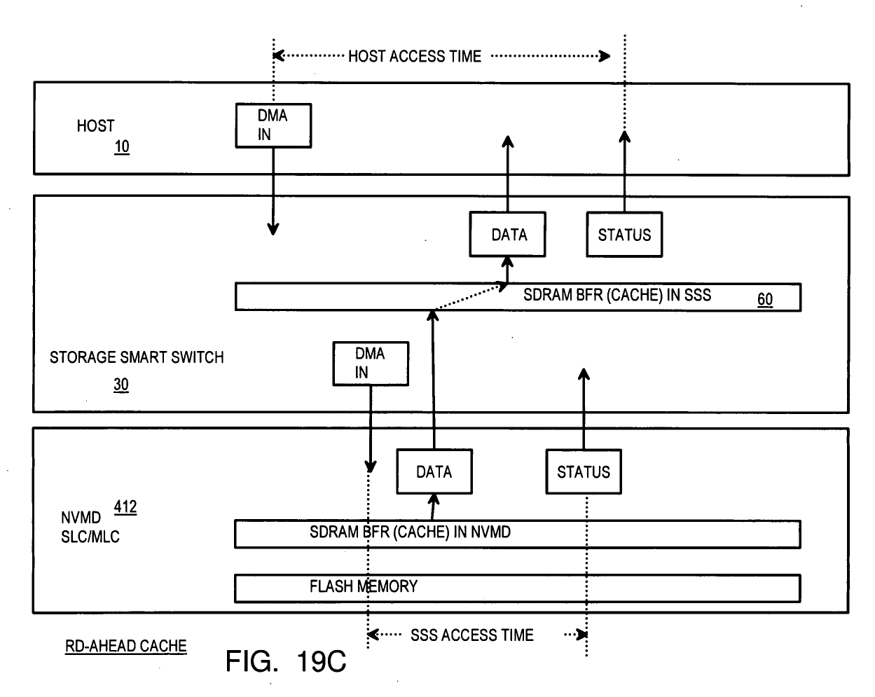

FIGS. 19A-C highlight data caching in a hybrid flash system. Data can be cached by SDRAM 60 in smart storage switch 30, and by another SDRAM buffer in NVM controller 76. See FIG. 1A of the parent application, U.S. Ser. No. 12/252,155, for more details of caching.

In FIG. 19A, SDRAM 60 operates as a write-back cache for upper-level smart storage switch 30. Host motherboard 10 issues a DMA out (write) command to smart storage switch 30, which sends back a DMA acknowledgement. Then host motherboard 10 sends data to smart storage switch 30, which stores this data in SDRAM 60. Once the host data is stored in SDRAM 60, smart storage switch 30 issues a successful completion status back to host motherboard 10. The DMA write is complete from the viewpoint of host motherboard 10, and the host access time is relatively short.

After the host data is stored in SDRAM 60, smart storage switch 30 issues a DMA write command to NVMD 412. The NVM controller returns a DMA acknowledgement, and then smart storage switch 30 sends the data stored in SDRAM 60. The data is buffered in the SDRAM buffer 77 in NVM controller 76 or another buffer and then written to flash memory. Once the data has been written to flash memory, a successful completion status back to smart storage switch 30. The internal DMA write is complete from the viewpoint of smart storage switch 30. The access time of smart storage switch 30 is relatively longer due to write-through mode. However, this access time is hidden from host motherboard 10.

In FIG. 19B, SDRAM 60 operates as a write-through cache, but the NVMD operates as a write-back cache. Host motherboard 10 issues a DMA out (write) command to smart storage switch 30, which sends back a DMA acknowledgement. Then host motherboard 10 sends data to smart storage switch 30, which stores this data in SDRAM 60.

After the host data is stored in SDRAM 60, smart storage switch 30 issues a DMA write command to NVMD 412. The NVM controller returns a DMA acknowledgement, and then smart storage switch 30 sends the data stored in SDRAM 60. The data is stored in the SDRAM buffer 77 in NVM controller 76 (FIG. 1) or another buffer and later written to flash memory. Once the data has been written to its SDRAM buffer, but before that data has been written to flash memory, a successful completion status is sent back to smart storage switch 30. The internal DMA write is complete from the viewpoint of smart storage switch 30.

Smart storage switch 30 issues a successful completion status back to host motherboard 10. The DMA write is complete from the viewpoint of host motherboard 10, and the host access time is relatively long.

In FIG. 19C, both NVMD 412 and smart storage switch 30 operate as a read-ahead cache. Host motherboard 10 issues a DMA in (read) command to smart storage switch 30 and waits for the read data.

In this case, smart storage switch 30 found no cache hit in SDRAM 60. SDRAM 60 then issues a DMA read command to NVMD 412. In this case, the NVM controller found cache hit, then reads the data from its cache, SDRAM buffer 77 in NVM controller 76 (FIG. 1), which has earlier read or write this data, such as by speculatively reading ahead after an earlier read or write. This data is sent to smart storage switch 30 and stored in SDRAM 60, and then passed on to host motherboard 10.

NVMD 412 sends a successful completion status back to smart storage switch 30. The internal DMA read is complete from the viewpoint of smart storage switch 30. Smart storage switch 30 issues a successful completion status back to host motherboard 10. The DMA read is complete from the viewpoint of host motherboard 10. The host access time is relatively long, but is much shorter than if flash memory had to be read.

### ALTERNATE EMBODIMENTS

Several other embodiments are contemplated by the inventors. For example. While storing page-mode-mapped data into SLC flash memory has been described, this SLC flash memory may be a MLC flash memory that is emulating SLC, such has shown in FIG. 2C. Page mode could also be used for MLC flash, especially when there is no available space in SLC. Hybrid flash chips that support both SLC and MLC modes could be used, or separate MLC and SLC flash chips could be used, either on the same module or on separate module boards, or integrated onto the motherboard or another board.

Alternatively, NVMD 412 can be one of the following: a block mode mapper with hybrid SLC/MLC flash memory, a block mode mapper with SLC or MLC, a page mode mapper with hybrid MLC/SLC flash memory, a page mode mapper with SLC or MLC. Alternatively, NVMD 412 in flash module 110 can include raw flash memory chips. NVMD 412 and smart storage switch 30 in flash module 73 can include raw flash memory chips and a flash controller as shown in FIGS. 3A-C of the parent application U.S. Ser. No. 12/252,155.

The hybrid mapping tables require less space in SRAM that a pure page-mode mapping table since only about 20% of the block are fully page mapped; the other 80% of the blocks are block-mapped, which requires much less storage than page-mapping. Copying of blocks for relocation is less frequent with page mapping since the sequential-writing rules of the MLC flash are violated less often in page mode than in block mode. This increases the endurance of the flash system and increases performance.

The mapping tables may be located in an extended address space, and may use virtual addresses or illegal addresses that are greater than the largest address in a user address space. Pages may remain in the host's page order or may be remapped to any page location. Rather than store a separate B/P bit, an extra address bit may be used, such as a MSB of the PBA stored for an entry. Other encodings are possible.

Many variations of FIG. 1 and others are possible. A ROM such as an EEPROM could be connected to or part of virtual storage processor 140, or another virtual storage bridge 42 and NVM controller 76 could connect virtual storage processor 140 to another raw-NAND flash memory chip or to NVM flash memory 68 that is dedicated to storing firmware for virtual storage processor 140. This firmware could also be stored in the main flash modules. Host storage bus 18 can be a Serial AT-Attachment (SATA) bus, a Peripheral Components Interconnect Express (PCIe) bus, a compact flash (CF) bus, or a Universal-Serial-Bus (USB), a Firewire 1394 bus, a Fibre Channel (FC) bus, etc. LBA storage bus interface 28 can be a Serial AT-Attachment (SATA) bus, an integrated device electronics (IDE) bus, a Peripheral Components Interconnect Express (PCIe) bus, a compact flash (CF) bus, a Universal-Serial-Bus (USB), a Secure Digital (SD) bus, a Multi-Media Card (MMC) bus, a Firewire 1394 bus, a Fibre Channel (FC) bus, various Ethernet buses, etc. NVM memory 68 can be SLC or MLC flash only or can be combined SLC/MLC flash. Hybrid mapper 46 in NVM controller 76 can perform one level of block mapping to a portion of SLC or MLC flash memory, and two levels of page mapping may be performed for the remaining SLC or MLC flash memory.

The flash memory may be embedded on a motherboard or SSD board or could be on separate modules. Capacitors, buffers, resistors, and other components may be added. Smart storage switch 30 may be integrated on the motherboard or on a separate board or module. NVM controller 76 can be integrated with smart storage switch 30 or with raw-NAND flash memory chips as a single-chip device or a plug-in module or board. In FIG. 4D, SDRAM 60 can be directly soldered to board 300 or a removable SDRAM module may be plugged into a module socket.

Using multiple levels of controllers, such as in a president-governor arrangement of controllers, the controllers in smart storage switch 30 may be less complex than would be required for a single level of control for wear-leveling, bad-block management, re-mapping, caching, power management, etc. Since lower-level functions are performed among flash memory chips 68 within each flash module by NVM controllers 76 as a governor function, the president function in smart storage switch 30 can be simplified. Less expensive hardware may be used in smart storage switch 30, such as using an 8051 processor for virtual storage processor 140 or smart storage transaction manager 36, rather than a more expensive processor core such as a an Advanced RISC Machine ARM-9 CPU core.

Different numbers and arrangements of flash storage blocks can connect to the smart storage switch. Rather than use LBA storage bus interface 28 or differential serial packet buses, other serial buses such as synchronous Double-Data-Rate (DDR), a differential serial packet data bus, a legacy flash interface, etc.

Mode logic could sense the state of a pin only at power-on rather than sense the state of a dedicated pin. A certain combination or sequence of states of pins could be used to initiate a mode change, or an internal register such as a configuration register could set the mode. A multi-bus-protocol chip could have an additional personality pin to select which serial-bus interface to use, or could have programmable registers that set the mode to hub or switch mode.

The transaction manager and its controllers and functions can be implemented in a variety of ways. Functions can be programmed and executed by a CPU or other processor, or can be implemented in dedicated hardware, firmware, or in some combination. Many partitionings of the functions can be substituted. Smart storage switch 30 may be hardware, or may include firmware or software or combinations thereof.

Overall system reliability is greatly improved by employing Parity/ECC with multiple NVM controllers 76, and distributing data segments into a plurality of NVM blocks. However, it may require the usage of a CPU engine with a DDR/SDRAM cache in order to meet the computing power requirement of the complex ECC/Parity calculation and generation. Another benefit is that, even if one flash block or flash module is damaged, data may be recoverable, or the smart storage switch can initiate a “Fault Recovery” or “Auto-Rebuild” process to insert a new flash module, and to recover or to rebuild the “Lost” or “Damaged” data. The overall system fault tolerance is significantly improved.

Wider or narrower data buses and flash-memory chips could be substituted, such as with 16 or 32-bit data channels. Alternate bus architectures with nested or segmented buses could be used internal or external to the smart storage switch. Two or more internal buses can be used in the smart storage switch to increase throughput. More complex switch fabrics can be substituted for the internal or external bus.

Data striping can be done in a variety of ways, as can parity and error-correction code (ECC). Packet re-ordering can be adjusted depending on the data arrangement used to prevent re-ordering for overlapping memory locations. The smart switch can be integrated with other components or can be a stand-alone chip.

Additional pipeline or temporary buffers and FIFO's could be added. For example, a host FIFO in smart storage switch 30 may be may be part of smart storage transaction manager 36, or may be stored in SDRAM 60. Separate page buffers could be provided in each channel. A clock source could be added.

A single package, a single chip, or a multi-chip package may contain one or more of the plurality of channels of flash memory and/or the smart storage switch.

A MLC-based flash module may have four MLC flash chips with two parallel data channels, but different combinations may be used to form other flash modules, for example, four, eight or more data channels, or eight, sixteen or more MLC chips. The flash modules and channels may be in chains, branches, or arrays. For example, a branch of 4 flash modules could connect as a chain to smart storage switch 30. Other size aggregation or partition schemes may be used for different access of the memory. Flash memory, a phase-change memory (PCM), or ferroelectric random-access memory (FRAM), Magnetoresistive RAM (MRAM), Memristor, PRAM, SONOS, Resistive RAM (RRAM), Racetrack memory, and nano RAM (NRAM) may be used.

The host can be a PC motherboard or other PC platform, a mobile communication device, a personal digital assistant (PDA), a digital camera, a combination device, or other device. The host bus or host-device interface can be SATA, PCIE, SD, USB, or other host bus, while the internal bus to a flash module can be PATA, multi-channel SSD using multiple SD/MMC, compact flash (CF), USB, or other interfaces in parallel. A flash module could be a standard PCB or may be a multi-chip modules packaged in a TSOP, BGA, LGA, COB, PIP, SIP, CSP, POP, or Multi-Chip-Package (MCP) packages and may include raw-NAND flash memory chips or raw-NAND flash memory chips may be in separate flash chips, or other kinds of NVM flash memory 68. The internal bus may be fully or partially shared or may be separate buses. The SSD system may use a circuit board with other components such as LED indicators, capacitors, resistors, etc.

Directional terms such as upper, lower, up, down, top, bottom, etc. are relative and changeable as the system or data is rotated, flipped over, etc. These terms are useful for describing the device but are not intended to be absolutes.

NVM flash memory 68 may be on a flash module that may have a packaged controller and flash die in a single chip package that can be integrated either onto a PCBA, or directly onto the motherboard to further simplify the assembly, lower the manufacturing cost and reduce the overall thickness. Flash chips could also be used with other embodiments including the open frame cards.

Rather than use smart storage switch 30 only for flash-memory storage, additional features may be added. For example, a music player may include a controller for playing audio from MP3 data stored in the flash memory. An audio jack may be added to the device to allow a user to plug in headphones to listen to the music. A wireless transmitter such as a BlueTooth transmitter may be added to the device to connect to wireless headphones rather than using the audio jack. Infrared transmitters such as for IRDA may also be added. A BlueTooth transceiver to a wireless mouse, PDA, keyboard, printer, digital camera, MP3 player, or other wireless device may also be added. The BlueTooth transceiver could replace the connector as the primary connector. A Bluetooth adapter device could have a connector, a RF (Radio Frequency) transceiver, a baseband controller, an antenna, a flash memory (EEPROM), a voltage regulator, a crystal, a LED (Light Emitted Diode), resistors, capacitors and inductors. These components may be mounted on the PCB before being enclosed into a plastic or metallic enclosure.

The background of the invention section may contain background information about the problem or environment of the invention rather than describe prior art by others. Thus inclusion of material in the background section is not an admission of prior art by the Applicant.

Any methods or processes described herein are machine-implemented or computer-implemented and are intended to be performed by machine, computer, or other device and are not intended to be performed solely by humans without such machine assistance. Tangible results generated may include reports or other machine-generated displays on display devices such as computer monitors, projection devices, audio-generating devices, and related media devices, and may include hardcopy printouts that are also machine-generated. Computer control of other machines is another tangible result.

Any advantages and benefits described may not apply to all embodiments of the invention. When the word “means” is recited in a claim element, Applicant intends for the claim element to fall under 35 USC Sect. 112, paragraph 6. Often a label of one or more words precedes the word “means”. The word or words preceding the word “means” is a label intended to ease referencing of claim elements and is not intended to convey a structural limitation. Such means-plus-function claims are intended to cover not only the structures described herein for performing the function and their structural equivalents, but also equivalent structures. For example, although a nail and a screw have different structures, they are equivalent structures since they both perform the function of fastening. Claims that do not use the word “means” are not intended to fall under 35 USC Sect. 112, paragraph 6. Signals are typically electronic signals, but may be optical signals such as can be carried over a fiber optic line.

The foregoing description of the embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

We claim:

1. A multi-level-controlled flash device comprising:
a smart storage switch which comprises:
an upstream interface to a host for receiving host commands to access non-volatile memory (NVM) and for receiving host data and a host address;
a smart storage transaction manager that manages transactions from the host;
a virtual storage processor that maps the host address to an assigned flash channel to generate a logical block address (LBA), the virtual storage processor performing a high level of mapping;
a virtual storage bridge between the smart storage transaction manager and a LBA bus;
a NVM controller, coupled to the LBA bus to receive the LBA generated by the virtual storage processor and the host data from the virtual storage bridge; and
a hybrid mapper, in the NVM controller, that maps the LBA to a physical block address (PBA), the hybrid mapper generating the PBA for block-mapped host data, and the hybrid mapper generating the PBA and a page number for host data that is page-mapped;
a plurality of flash channels that include the assigned flash channel, wherein a flash channel comprises:
NVM flash memory, coupled to the NVM controller, for storing the host data at a block location identified by the PBA generated by the hybrid mapper in the NVM controller, and at a page location identified by the page number for the page-mapped host data;
whereby the hybrid mapper performs address mapping for block-mapped host data, and also performs address mapping for page-mapped host data to access the NVM flash memory.

2. The multi-level-controlled flash device of claim 1 wherein the hybrid mapper further comprises:
a first-level mapping table accessed by the hybrid mapper, the first-level mapping table having entries that store the PBA for block-mapped host data, and that store a virtual pointer when the host data is page-mapped; and
a second-level mapping table, accessed by the hybrid mapper and located by the virtual pointer read from entries in the first-level mapping table, the second-level mapping table having entries that store the PBA and a page number for host data that is page-mapped.

3. The multi-level-controlled flash device of claim 1 wherein the LBA bus comprises a Serial AT-Attachment (SATA) bus, a Serial small-computer system interface (SCSI) (SAS) bus, a fiber-channel (FC) bus, an InfiniBand bus, an integrated device electronics (IDE) bus, a Peripheral Components Interconnect Express (PCIe) bus, a compact flash (CF) bus, a Universal-Serial-Bus (USB), a Secure Digital Bus (SD), a MultiMediaCard (MMC), or a LBA bus protocol which transfers read and write commands, a starting page address with a sector offset, and a sector count.

4. The multi-level-controlled flash device of claim 2 wherein entries in the first-level mapping table further comprise:
a block-page bit that indicates when host data mapped by an entry is block-mapped and uses the PBA stored in the first-level mapping table, and when the host data is page-mapped and uses the virtual pointer to locate the second-level mapping table, and uses the PBA and the page number from an entry in the second-level mapping table,
whereby both block-mapped and page-mapped host data are identified by the block-page bit.

5. The multi-level-controlled flash device of claim 1 wherein the NVM flash memory comprise:
multi-level-cell (MLC) flash memory that stores multiple bits of data per physical flash-memory cell, wherein a physical flash-memory cell has at least four states generating at least four voltages during sensing for read;
single-level-cell (SLC) flash memory emulated by a portion of the MLC flash memory storing only one bit of data per physical flash-memory cell, wherein a physical flash-memory cell has two states;
wherein the MLC flash memory have a higher density than the SLC flash memory, and the SLC flash memory have a higher reliability than the MLC flash memory,
whereby flash memory is a hybrid flash memory with both MLC and SLC flash memory.

6. The multi-level-controlled flash device of claim 1 wherein the NVM flash memory comprises:
a portion for storing the block-mapped host data; and
another portion for storing the page-mapped host data;
wherein frequently-changed host data or host data with a sector count that is less than a sector count threshold are page-mapped;
wherein the NVM flash memory can be either MLC or SLC flash memories.

7. The multi-level-controlled flash device of claim 6 wherein the hybrid mapper further comprises:
a sector-count comparator that compares a sector count (SC) that identifies a number of sectors of the host data to a SC threshold and sets the block-page bit in the entry in the first-level mapping table to indicate block-mapped host data when the sector count exceeds the SC threshold, and clears block-page bit in the entry in the first-level mapping table to indicate page-mapped host data when the sector count does not exceed the SC threshold,
whereby the sector count determines when the host data is block-mapped and when the host data is page-mapped.

8. The multi-level-controlled flash device of claim 7 wherein entries in the first-level mapping table further comprise:
a frequency counter (FC) that indicates a relative number of times that host data mapped by an entry has been written;
wherein the hybrid mapper further comprises:
a frequency-count comparator that compares the frequency counter to a FC threshold and clears block-page bit in the entry in the first-level mapping table to indicate page-mapped host data when the frequency counter exceeds the FC threshold,
whereby the frequency counter determines when the host data is block-mapped and when the host data is page-mapped.

9. A hybrid-mapped solid-state disk comprising:
volatile memory buffer means for temporarily storing host data in a volatile memory that loses data when power is disconnected;
smart storage switch means for switching host commands to a plurality of downstream devices, the smart storage switch means comprising:
upstream interface means, coupled to a host, for receiving host commands to access flash memory and for receiving host data and a host address;
smart storage transaction manager means for managing transactions from the host;
virtual storage processor means for translating the host address to an assigned flash channel to generate a logical block address (LBA), the virtual storage processor means performing a first level of mapping;
virtual storage bridge means for transferring host data and the LBA between the smart storage transaction manager means and a LBA bus;
data striping means for dividing the host data into data segments that are assigned to different ones of the plurality of flash channels;
a plurality of flash channels that include the assigned flash channel, wherein a flash channel comprises:
lower-level controller means for controlling flash operations, coupled to the LBA bus to receive the LBA generated by the virtual storage processor means and the host data from the virtual storage bridge means;
hybrid mapper means, coupled to the lower-level controller means, for mapping the LBA to a physical block address (PBA);
first-level mapping table means, accessed by the hybrid mapper means, for storing entries that store the PBA for block-mapped host data, and that store a virtual pointer when the host data is page-mapped;
second-level mapping table means, accessed by the hybrid mapper means, and located by the virtual pointer read from entries in the first-level mapping table means, for storing second entries that store the PBA and a page number for host data that is page-mapped;
NVM flash memory means, coupled to the lower-level controller means, for storing the block-mapped host data at a block location identified by the PBA stored by the first-level mapping table means, and for storing the page-mapped host data at a page location identified by the PBA and the page number stored by the second-level mapping table means;
wherein the NVM flash memory means in the plurality of flash channels are non-volatile memory that retain data when power is disconnected,
whereby address mapping is performed at two levels for page-mode host data and at one level for block-mode host data to access the NVM flash memory means.

10. The hybrid-mapped solid-state disk of claim 9 wherein a stripe depth is equal to N times a stripe size, wherein N is a whole number of the plurality of flash channels, and wherein the stripe size is equal to a number of pages that can be simultaneously written into one of the plurality of flash channels.

11. The hybrid-mapped solid-state disk of claim 9 wherein the flash channel comprises a Non-Volatile-Memory Device (NVMD) that is physically mounted to a host motherboard through a connector and socket, by direct solder attachment, or embedded within the host motherboard.

12. The hybrid-mapped solid-state disk of claim 9 wherein the NVM flash memory means comprises a flash memory, a phase-change memory (PCM), ferroelectric random-access memory (FRAM), Magnetoresistive RAM (MRAM), Memristor, PRAM, SONOS, Resistive RAM (RRAM), Racetrack memory, or nano RAM (NRAM).

13. The hybrid-mapped solid-state disk of claim 9 wherein entries in the first-level mapping table means further comprise:
block-page means for indicating when host data mapped by an entry is block-mapped and uses the PBA stored in the first-level mapping table means, and when the host data is page-mapped and uses the virtual pointer to locate the second-level mapping table means, and uses the PBA and the page number from an entry in the second-level mapping table means,
whereby both block-mapped and page-mapped host data are identified by the block-page means.

14. The hybrid-mapped solid-state disk of claim 13 wherein the NVM flash memory means further comprise:
multi-level-cell (MLC) flash memory means for storing multiple bits of data per physical flash-memory cell, wherein a physical flash-memory cell has at least four states generating at least four voltages during sensing for read;
single-level-cell (SLC) flash memory means for storing only one bit of data per physical flash-memory cell, wherein a physical flash-memory cell has two states;
wherein the MLC flash memory means have a higher density than the SLC flash memory means, and the SLC flash memory means have a higher reliability than the MLC flash memory means,
whereby flash memory is a hybrid flash memory with both MLC and SLC flash memory means.

15. The hybrid-mapped solid-state disk of claim 13 wherein the NVM flash memory means further comprises:
block-mapped memory means for storing the block-mapped host data at a block location identified by the PBA stored by the first-level mapping table means;
page-mapped memory means for storing the page-mapped host data at a page location identified by the PBA and the page number stored by the second-level mapping table means;
wherein the block-mapped memory means occupies a larger portion of a total memory capacity than does the page-mapped memory means.

16. The hybrid-mapped solid-state disk of claim 15 wherein the hybrid mapper means further comprises:
sector-count comparator means for comparing a sector count (SC) that identifies a number of sectors of the host data to a SC threshold and sets the block-page means in the entry in the first-level mapping table means to indicate block-mapped host data when the sector count exceeds the SC threshold, and clears block-page means in the entry in the first-level mapping table means to indicate page-mapped host data when the sector count does not exceed the SC threshold,
whereby the sector count determines when the host data is block-mapped and when the host data is page-mapped.

17. A multi-level-controller device comprising:
a smart storage switch which comprises:
an upstream interface to a host for receiving host commands to access non-volatile memory (NVM) and for receiving host data and a host address;
a smart storage transaction manager that manages transactions from the host;
a virtual storage processor that maps the host address to an assigned flash module to generate a logical block address (LBA), the virtual storage processor performing a mapping for data striping;
a virtual storage bridge between the smart storage transaction manager and a LBA bus;
a volatile memory buffer for temporarily storing the host data in a volatile memory that loses data when power is disconnected;
wherein the volatile memory buffer operates as a write-through cache, a write-back cache, or a read-ahead cache;
a NVM controller, coupled to the LBA bus to receive the LBA generated by the virtual storage processor and the host data from the virtual storage bridge;
a logical to physical address mapper, in the NVM controller, that maps the LBA to a physical block address (PBA);
a plurality of NVM devices (NVMD) that include the assigned NVMD, wherein a NVMD comprises:
raw-NAND flash memory chips, coupled to the NVM controller, for storing the host data at a block location identified by the PBA generated by the logical to physical mapper in the NVM controller;
whereby address mapping is performed to access the raw-NAND flash memory chips.

18. A logical-block-address (LBA) flash module comprising:
a substrate having wiring traces printed thereon, the wiring traces for conducting signals;
a plurality of metal contact pads along a first edge of the substrate, the plurality of contact pads for mating with a memory module socket on a board;
a plurality of Non-Volatile-Memory Devices (NVMD) mounted on the substrate for storing host data;
wherein the plurality of NVMD retain data when power is disconnected to the flash module;
a logical-block-address LBA bus formed by wiring traces on the substrate that connect to the plurality of metal contact pads;
wherein the plurality of NVMD are coupled by the LBA bus;
wherein the plurality of NVMD store host data sent over the plurality of metal pads at a block location identified by the LBA from the Host;
wherein the flash module connects the plurality of NVMD to the board through the LBA bus.

19. A logical-block-address (LBA) flash module comprising:
a substrate having wiring traces printed thereon, the wiring traces for conducting signals;
a plurality of metal contact pads along a first edge of the substrate, the plurality of contact pads for mating with a memory module socket on a board;
a plurality of Non-Volatile-Memory Devices (NVMD) mounted on the substrate for storing host data from a host;
wherein the plurality of NVMD retain data when power is disconnected to the flash module;
a logical-block-address LBA bus formed by wiring traces on the substrate that connect to the plurality of metal contact pads;
a Smart Switch Storage (SSS) Controller, mounted on the substrate, coupled to the LBA bus to receive a LBA from the board through the plurality of metal contact pads;
wherein the plurality of NVMD are coupled by the LBA bus to the SSS controller;
wherein the plurality of NVMD store host data sent over the plurality of metal pads at a block location identified by the LBA generated by the SSS controller.
